(19) United States
(12) Patent Application Publication
(10) Pub. No.: US 2008/0215595 A1
(43) Pub. Date: Sep. 4, 2008

(54) Data distribution system, terminal apparatus, connection candidate introduction apparatus, information processing method and recording medium with program recorded thereon

(75) Inventor: Katsuro Suda, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-shi (JP)

(21) Appl. No.: 12/071,703

(22) Filed: Feb. 25, 2008

(30) Foreign Application Priority Data
Mar. 2, 2007 (JP) 2007-053466

(51) Int. Cl. G06F 17/30

(52) U.S. Cl. 707/10; 707/E17.01

(57) ABSTRACT

To provide a data distribution system, terminal apparatus, a connection candidate introduction apparatus, a recording medium on which a program is recorded, and an information processing method, which can prevent an occurrence of a circular connection between the terminal apparatus.

In a data distribution system including a data distribution apparatus, a connection candidate introduction apparatus, and a plurality of terminal apparatus, logically connected, in a multilevel hierarchical structure with the data distribution apparatus as an apex, which carry out a reception and relay of data, each terminal apparatus acquires connection position information indicating its own connection position in the hierarchical structure, acquires, from the connection candidate introduction apparatus, connection information for connecting to terminal apparatus which are connection candidates, when reconnecting to the hierarchical structure, acquires, from terminal apparatus corresponding to the connection information, hierarchical structure connection position information of those terminal apparatus, and selects, as a connection destination, a terminal apparatus which is not farther downstream than itself in the hierarchical structure, based on its own connection position information, and on the connection position information of the connection candidates.

### CROSS-REFERENCE TO RELATED APPLICATION(S)

This application is based on and claims the benefit of priority from Japanese Patent Application No. 2007-053466 filed on Mar. 2, 2007; the entire contents of which are incorporated herein by reference.

### BACKGROUND OF THE INVENTION

1. Field of the Invention

The present invention relates to a data distribution system, and to a terminal apparatus, an information processing method, and a recording medium on which a program is recorded, in the same system.

2. Description of the Related Art

To date, a data distribution system which, by a client who is a viewer or listener connecting a terminal apparatus such as a personal computer to an information communication network (hereafter referred to simply as a “network”) typified by an internet, and receiving data such as video contents and music contents provided by a broadcasting station or the like, makes the received data viewable or listenable to at each terminal apparatus, has been widely known.

In recent years, as this kind of data distribution system, an invention has been contrived relating to a system called a P2P (Peer To Peer) communication, in which a terminal apparatus which receives data from a distribution source relays the data along with reproducing them, and distributes them to a terminal apparatus of another client.

A data distribution system using the P2P communication is configured in such a way that, including, as shown in FIG. 25, a data distribution apparatus 400, which distributes data via the network, a plurality of terminal apparatus 401 to 430 which are logically connected, in a multilevel tree-shaped hierarchical structure on the network, with the data distribution apparatus 400 as an apex, and receive and relay data distributed from the data distribution apparatus 400, and a connection candidate introduction apparatus 500 which, managing a connection condition of each terminal apparatus 401 to 430 in the hierarchical structure, introduces the terminal apparatus 401 to 430 which are hierarchical structure connection candidates to a terminal apparatus, among 401 to 430, which has transmitted a request for a connection to the hierarchical structure, the data distributed from the data distribution apparatus 400 are sequentially distributed, by a relay function of the terminal apparatus 401 to 430, from an upstream terminal apparatus among 401 to 430 of the hierarchical structure to a downstream terminal apparatus among 401 to 430, and the data are distributed to all of the terminal apparatus 401 to 430 connected to the hierarchical structure (for example, refer to Japanese Unexamined Patent Publication No. 2006-325107).

### SUMMARY OF THE INVENTION

In the heretofore described data distribution system, as the connection candidate introduction apparatus 500 manages the connection condition of all of the terminal apparatus 401 to 430 connected to the hierarchical structure, in the event that a quantity of the terminal apparatus 401 to 430 connected to the hierarchical structure increases, there has been a danger that a processing burden of the connection candidate introduction apparatus 500 increases.

In the event that the processing burden increases in this way, there occurs a problem in that there is a lengthening of a processing time taken, in the connection candidate introduction apparatus 500, to decide connection candidates to be introduced to the terminal apparatus which has transmitted the request for the connection to the hierarchical structure, and a lengthening in a time until the terminal apparatus which has transmitted the request for the connection connects to the hierarchical structure.

Therein, in order to reduce the processing burden of the connection candidate introduction apparatus 500, it is conceivable to have a configuration which causes the connection candidate introduction apparatus 500 to manage only identification information for identifying the terminal apparatus 401 to 430 connected to the hierarchical structure, and information indicating an IP (Internet Protocol) address thereof, notify the terminal apparatus which has transmitted the connection request, and cause each terminal apparatus to search for a connection destination candidate, but in the event of configuring in this way, there being a danger of a circular connection occurring in the hierarchical structure, there has been a danger that it becomes impossible to receive the data distributed from the data distribution apparatus 400 in terminal apparatus which have become circularly connected.

For example, in a hierarchical structure shown in FIG. 26, when a terminal apparatus 403 temporarily withdraws from the hierarchical structure, and connects to the hierarchical structure again, the terminal apparatus 403, as a plurality of terminal apparatus 407, 408, and 415 to 418 are connected downstream of it, may connect to the terminal apparatus 418, which is downstream of the terminal apparatus 403.

In this way, in the event that the terminal apparatus 403 and the terminal apparatus 408 are connected, as shown in FIG. 27, as a connection of the terminal apparatus 403, the terminal apparatus 408, and the terminal apparatus 418 becomes a circular connection, the terminal apparatus 407, 408, and 415 to 418 which receive a relay of data from the terminal apparatus 403 fall into a condition in which they are unable to receive the data distributed from the data distribution apparatus 400.

Therein, according to one embodiment of the invention, a data distribution system includes: a data distribution apparatus which distributes data via a network; a plurality of terminal apparatus, logically connected, in a multilevel hierarchical structure on the network, with the data distribution apparatus as an apex, which receive and relay data distributed from the data distribution apparatus; and a connection candidate introduction apparatus which introduces terminal apparatus which are hierarchical structure connection candidates to a terminal apparatus which has transmitted a request for a connection to the hierarchical structure. The data distributed from the data distribution apparatus are sequentially distributed, by a relay function of the terminal apparatus, from an upstream terminal apparatus of the hierarchical structure to a downstream terminal apparatus. Each terminal apparatus includes: a connection position acquisition unit which acquires connection position information indicating a connection position of its own apparatus in the hierarchical structure, in a condition in which it is connected to the hierarchical structure; a connection candidate acquisition unit which acquires, from the connection candidate introduction apparatus, connection information for connecting to terminal apparatus which are the connection candidates, when reconnecting to the hierarchical structure; a connection candidate position acquisition unit which acquires, from terminal apparatus corresponding to the connection information acquired by the connection candidate acquisition unit, connection position information of those terminal apparatus; and a connection destination selection unit which selects, as a connection destination, a terminal apparatus among the connection candidates, of which the connection position in the hierarchical structure is not farther downstream than the connection position of its own apparatus, based on the connection position information acquired by the connection candidate position acquisition unit, and on the connection position information acquired by the connection position acquisition unit.

### BRIEF DESCRIPTION OF THE DRAWINGS

FIG. 1 is an illustration showing a data distribution system according to an embodiment of the invention;

FIG. 2 is an illustration showing the data distribution system according to the embodiment of the invention;

FIGS. 3A to 3D are illustrations showing the data distribution system according to the embodiment of the invention;

FIGS. 4A and 4B are illustrations showing the data distribution system according to the embodiment of the invention;

FIG. 5 is an illustration showing the data distribution system according to the embodiment of the invention;

FIGS. 6A and 6B are illustrations showing the data distribution system according to the embodiment of the invention;

FIG. 7 is an illustration showing the data distribution system according to the embodiment of the invention;

FIGS. 8A and 8B are illustrations showing an in-reconnection list table;

FIG. 9 is a functional block diagram showing a data distribution apparatus;

FIG. 10 is a functional block diagram showing a connection candidate introduction apparatus;

FIG. 11 is a functional block diagram showing a terminal apparatus;

FIG. 12 is an illustration showing information processes carried out by a controller of the connection candidate introduction apparatus;

FIG. 13 is an illustration showing information processes carried out by the controller of the connection candidate introduction apparatus;

FIG. 14 is an illustration showing information processes carried out by the controller of the connection candidate introduction apparatus;

FIG. 15 is an illustration showing information processes carried out by the controller of the connection candidate introduction apparatus;

FIG. 16 is an illustration showing information processes carried out by the controller of the connection candidate introduction apparatus;

FIG. 17 is an illustration showing information processes carried out by a controller of the terminal apparatus;

FIG. 18 is an illustration showing information processes carried out by the controller of the terminal apparatus;

FIG. 19 is an illustration showing information processes carried out by the controller of the terminal apparatus;

FIG. 20 is an illustration showing information processes carried out by the controller of the terminal apparatus;

FIG. 21 is an illustration showing information processes carried out by the controller of the terminal apparatus;

FIG. 22 is an illustration showing information processes carried out by the controller of the terminal apparatus;

FIG. 23 is an illustration showing information processes carried out by the controller of the terminal apparatus;

FIG. 24 is an illustration showing information processes carried out by the controller of the terminal apparatus;

FIG. 25 is an illustration showing a heretofore known data distribution system;

FIG. 26 is an illustration showing the heretofore known data distribution system; and

FIG. 27 is an illustration showing the heretofore known data distribution system.

### DESCRIPTION OF THE PREFERRED EMBODIMENTS

Hereafter, a specific description will be given of one embodiment of the invention, with reference to the drawings.

Data Distribution System

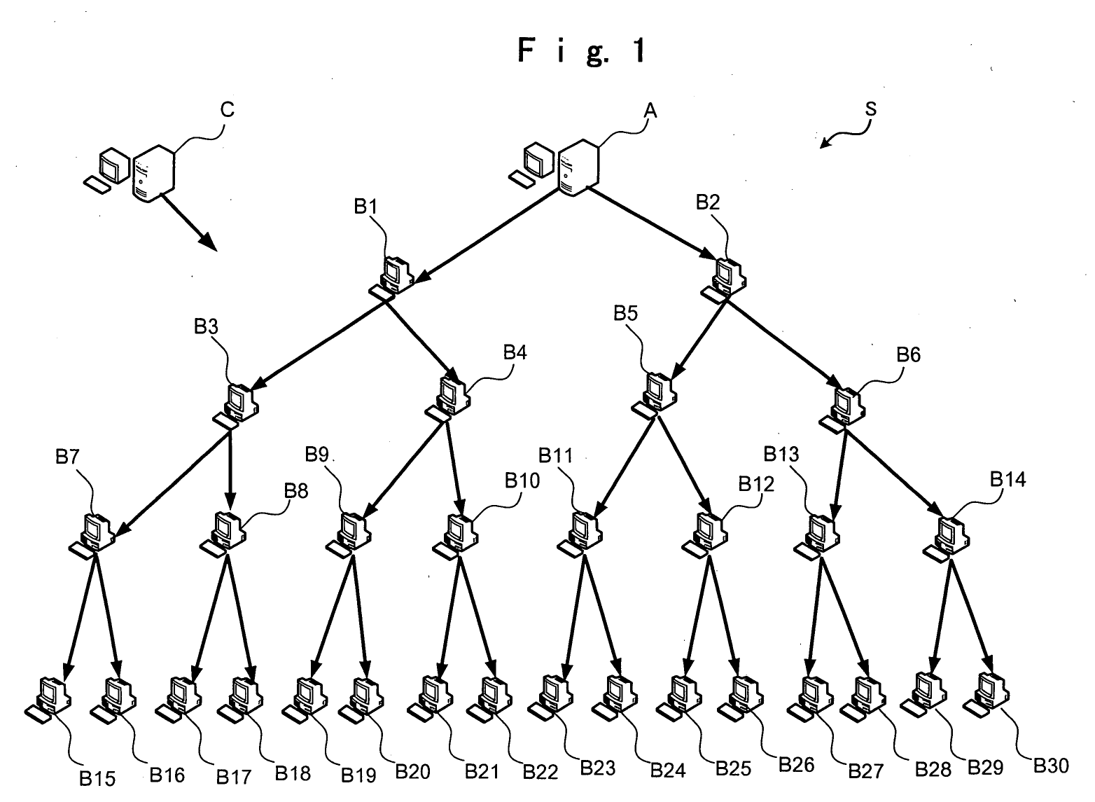

Firstly, a description will be given of an outline and the like of a data distribution system according to the embodiment. As shown in FIG. 1, a data distribution system S of the embodiment includes a data distribution apparatus A, which distributes data such as video contents and music contents, via a communication network typified by an internet, a plurality of terminal apparatus B1 to B30 (hereafter, in a case of indicating an optional terminal apparatus, called a terminal apparatus B) which are logically connected, in a multilevel tree-shaped hierarchical structure on the network, with the data distribution apparatus A as an apex, and receive and relay data distributed from the data distribution apparatus A using a P2P technology, and a connection candidate introduction apparatus C, which introduces terminal apparatus B which are hierarchical structure connection candidates to a terminal apparatus B which has transmitted a request for a connection or a request for a reconnection to the hierarchical structure.

Although, in the embodiment, a description is given supposing that each of the data distribution apparatus A and the terminal apparatus B has up to two terminal apparatus B which can be connected downstream of itself in the hierarchical structure, the invention not being limited to this, it can also be applied to a data distribution system including the terminal apparatus B and data distribution apparatus A each of which has three or more terminal apparatus B which can be connected downstream of itself.

In the data distribution system S, a configuration is such that, by the data distributed from the data distribution apparatus A being distributed sequentially, by a relaying function of each terminal apparatus B, from an upstream terminal apparatus B to downstream terminal apparatus B of the hierarchical structure, all terminal apparatus B connected to the hierarchical structure receive the data distributed from the data distribution apparatus A, and a user of each terminal apparatus B can view or listen to the contents.

In particular, although the connection candidate introduction apparatus C of the embodiment is configured in such a way as to receive, and sequentially store, connection information from the terminal apparatus B which has transmitted the request for connection to the hierarchical structure, composed of identification information (hereafter referred to as a “node number”) for identifying the terminal apparatus B, and information on a location (hereafter referred to as an “IP address”) in the network of each terminal apparatus B, it is configured in such a way as not to store information such as that which indicates a structural system of the hierarchical structure which changes along with a connection of the terminal apparatus B to the hierarchical structure, or a disconnection of the terminal apparatus B from the hierarchical structure, or whether or not the terminal apparatus B connected to the hierarchical structure is in a condition in which another terminal apparatus B can be connected downstream thereof.

Then, the connection candidate introduction apparatus C, by transmitting node numbers and IP addresses relating to a plurality of terminal apparatus B, optionally selected from among terminal apparatus B currently connected to the hierarchical structure, to the terminal apparatus B which has transmitted the request for reconnection to the hierarchical structure, introduces terminal apparatus which are the connection candidates in the hierarchical structure.

In this way, as the connection candidate introduction apparatus C of the embodiment is configured in such a way as to store only minimally essential information, being the node numbers and IP addresses of the terminal apparatus B connected to the hierarchical structure, as the information for introducing the terminal apparatus B which are the connection candidates, an amount of information processing carried out for introducing the terminal apparatus B which are the connection candidates can be reduced to a minimum.

Then, the connection candidate introduction apparatus C includes a connection request reception unit, which receives a request from the terminal apparatus B for a new connection to the hierarchical structure, a reconnection request reception unit, which receives a request from the terminal apparatus B for a reconnection to the hierarchical structure, an in-reconnection connection position reception unit, which receives, from the terminal apparatus B which has transmitted the request for the reconnection, connection position information, to be described hereafter, indicating a connection position of the terminal apparatus B in the hierarchical structure, an in-reconnection connection position storage unit, which stores, for a period until a reconnection of the terminal apparatus B which has transmitted the request for the reconnection is complete, the connection position information received by the in-reconnection connection position reception unit, and a connection position transmission unit, which transmits the connection position information stored in the in-reconnection connection position storage unit to the terminal apparatus B which has transmitted the request for the connection or the request for the reconnection.

In this way, the connection candidate introduction apparatus C, by not only transmitting the node numbers and IP addresses of the plurality of terminal apparatus B selected as the connection candidates to the terminal apparatus B which has transmitted the request for the connection or the request for the reconnection, but also transmitting information relating to terminal apparatus B currently in the process of being reconnected to the hierarchical structure, prevents the terminal apparatus B which is trying to connect to the hierarchical structure from mistakenly connecting to another terminal apparatus B which is in the process of being reconnected.

Also, the connection candidate introduction apparatus C includes a reconnection completion information reception unit, which receives reconnection completion information from the terminal apparatus B indicating that the reconnection to the hierarchical structure is complete, and a connection position storage and processing unit which, in response to the reconnection completion information reception unit receiving the reconnection completion information, deletes connection position information of the terminal apparatus B for which the reconnection is complete from the in-reconnection connection position storage unit. When a specific condition is met, the connection candidate introduction apparatus C updates the information stored in the in-reconnection connection position storage unit.

Also, the connection position storage and processing unit with which the connection candidate introduction apparatus C is equipped, when deleting the connection position information from the in-reconnection connection position storage unit, repeats a storage and update process a predetermined number of times which stores connection position information of the terminal apparatus B connected downstream of a terminal apparatus B corresponding to the connection position information to be deleted, and deletes it after a predetermined period elapses.

In this way, the connection position storage and processing unit, by updating the information stored in the in-reconnection connection position storage unit, prevents the terminal apparatus B which is trying to connect to the hierarchical structure from mistakenly connecting to a terminal apparatus B, for which the reconnection process is not complete, connected downstream of a terminal apparatus B for which the reconnection process has just been completed.

Also, the terminal apparatus B of the embodiment, when reconnecting to the hierarchical structure, includes a connection candidate acquisition unit, which acquires connection information from the connection candidate introduction apparatus C for connecting to the terminal apparatus B which are the connection candidates.

The connection candidate acquisition unit with which the terminal apparatus B is equipped acquires, as the connection information from the connection candidate introduction apparatus C, the node numbers and IP addresses of the plurality of the terminal apparatus B which the connection candidate introduction apparatus C has optionally selected.

Also, the terminal apparatus B, in a condition in which it is connected to the hierarchical structure, includes a connection position acquisition unit which acquires, from an upstream terminal B connected to its own apparatus, connection position information indicating a connection position of its own apparatus in the hierarchical structure, and a connection position storage unit, which stores the connection position information of its own apparatus acquired by the connection position acquisition unit.

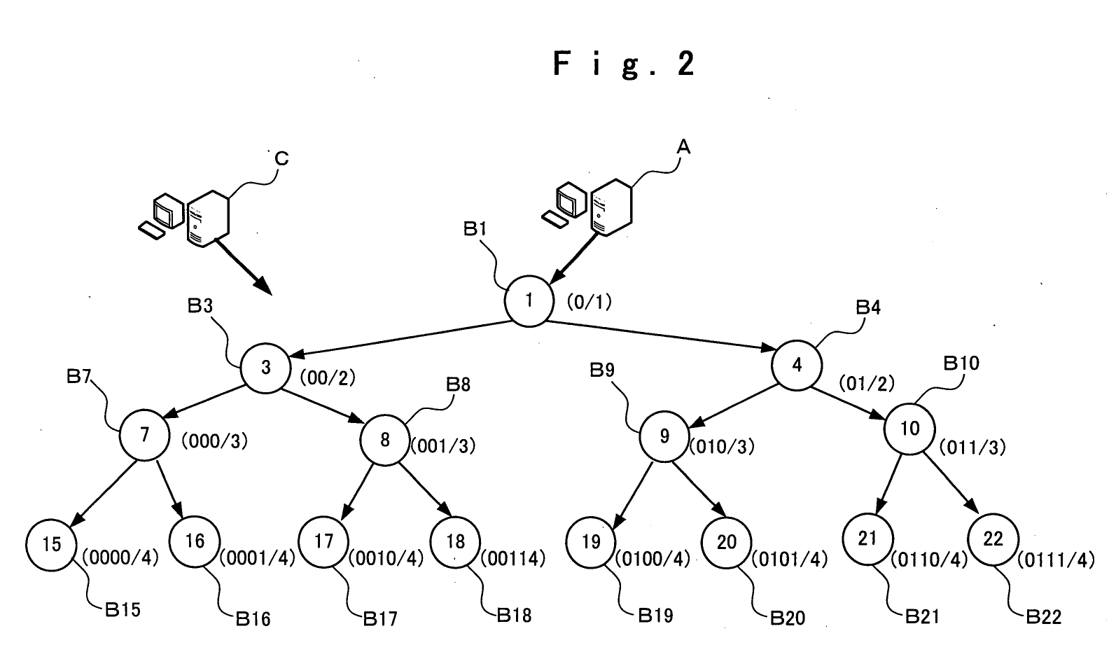

Herein, a description will be given of the connection position information, referring to FIG. 2. FIG. 2 is an illustration showing a left half of the hierarchical structure shown in FIG. 1. In FIG. 2, each terminal apparatus B being indicated by a circle, a number inside the circle indicates a node number of the terminal apparatus B, while a numerical sequence written on a right side of the circle indicates connection position information of the terminal apparatus B.

As shown in FIG. 2, the connection position information of each terminal apparatus B is information which specifies a connection position of each terminal apparatus B in the hierarchical structure, by means of a data distribution route from the data distribution apparatus A to each terminal apparatus B.

That is, in the connection position information, information indicating the data distribution route from the data distribution apparatus A to its own apparatus (hereafter referred to as “path information”) is written on a left side of a slash (/), while information indicating on which level of the hierarchical structure its own apparatus is connected (hereafter referred to as “depth information”) is written on a right side of the slash (/).

To give a specific description, the path information indicates sequentially, by 0 or 1, in a first column, whether its own apparatus is connected to a right or left side of an apparatus one level above, also, in a second column, whether the apparatus one level above, to which its own apparatus is connected, is connected to a right or left side of an apparatus two levels above, also, in a third column and a fourth column, whether the apparatus two levels above, to which the terminal apparatus B is connected, is connected to a right or left side of an apparatus three levels and four levels above.

Also, the depth information indicates sequentially a level one level below the data distribution apparatus A in the hierarchical structure by 1, a level two levels below the data distribution apparatus A by 2, and a level three levels below the data distribution apparatus A by 3.

For example, in a case of a terminal apparatus B20 shown in FIG. 2, as it is connected in a level four levels below the data distribution apparatus A, the depth information is 4, as it is connected to a right side of a terminal apparatus B9, one level above, which is connected to the terminal apparatus B20, the first column of the path information is 1, as the terminal apparatus B9 is connected to a left side of a terminal apparatus B4, one level above (two levels above the terminal apparatus B20), the second column of the path information is 0, as the terminal apparatus B4 is connected to a right side of a terminal apparatus B1, one level above (three levels above the terminal apparatus B20), the third column of the path information is 1, and as the terminal apparatus B1 is connected to a left side of the data distribution apparatus A, one level above (four levels above the terminal apparatus B20), the fourth column of the path information is 0.

Although, in the embodiment, a configuration is such that a number of levels from the data distribution apparatus A is written as the depth information while, as the path information, in the event that its own apparatus is connected to a left side of a terminal apparatus B in an upper level, or of the data distribution apparatus A, 0 is written in a column corresponding to the level and, in the event that it is connected to a right side, 1 is written in a column corresponding to the level, the depth information and path information not being limited to this, as long as it indicates an absolute position of each terminal apparatus B in the hierarchical structure, it is possible to make it optional information.

Also, each terminal apparatus B includes a downstream connection position calculation unit, which calculates connection position information of a terminal apparatus B connected downstream of its own apparatus, and a downstream connection position transmission unit, which transmits the connection position information calculated by the downstream connection position calculation unit to the terminal apparatus B connected downstream.

That is, the downstream connection position calculation unit of the terminal apparatus B, as well as generating depth information in which 1 is added to the depth information of its own apparatus, carries a number of each column of the path information of its own apparatus, and generates path information in which 0 is written in a now blank first column of the path information, in the event that the terminal apparatus B to be connected downstream of its own apparatus is connected to a left side of its own apparatus, and 1 in the event that it is connected to a right side, and generates the connection position information of the terminal apparatus B connected downstream of its own apparatus.

Then, the downstream connection position transmission unit of the terminal apparatus B transmits the connection position information generated in this way to the terminal apparatus B connected downstream.

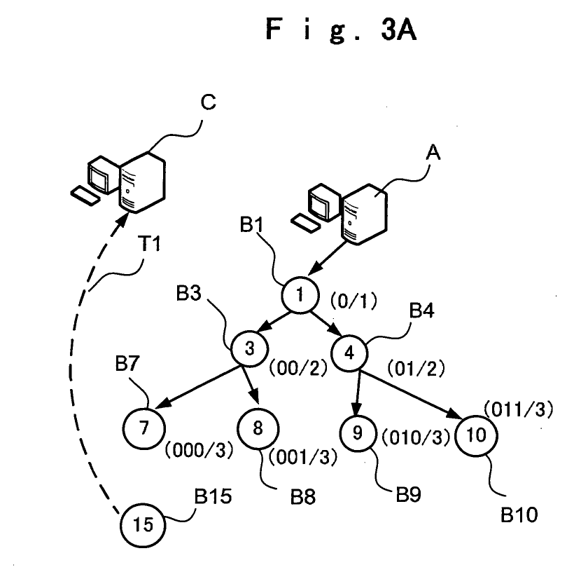

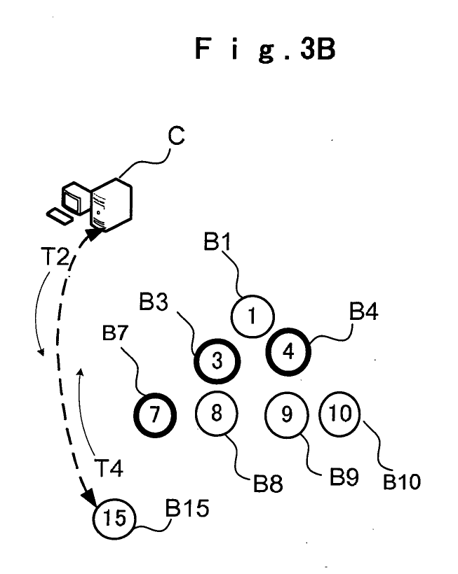

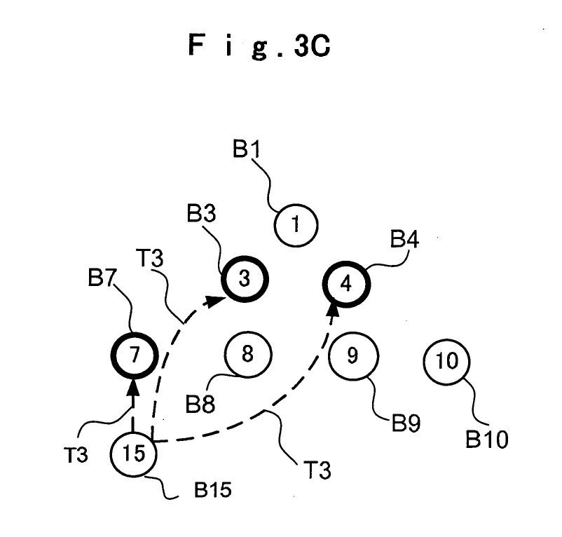

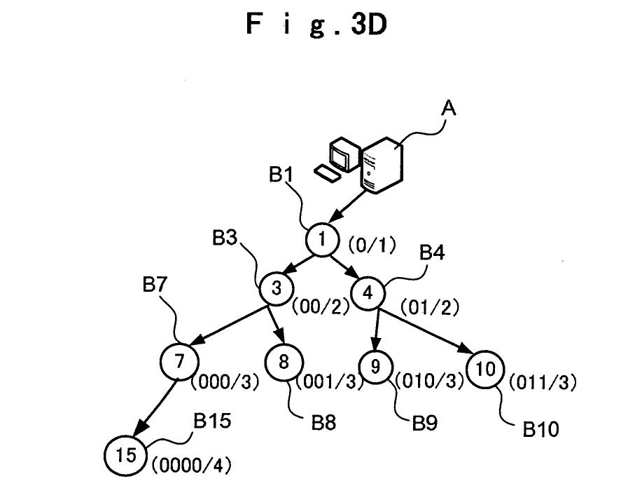

Hereafter, a description will be given, referring to FIGS. 3A to 3D, of a procedure from the terminal apparatus B configured in this way newly connecting to the hierarchical structure until acquiring its own connection position information. Herein, a description will be given with a case in which a terminal apparatus B15, shown in FIG. 3, newly connects to the hierarchical structure as an example.

As shown in FIG. 3A, now, in a case in which the terminal apparatus B15 (herein referred to as a “new terminal apparatus B15”) newly connects to a hierarchical structure configured of the data distribution apparatus A and seven terminal apparatus B1, B3, B4, B7, B8, B9 and B10, the new terminal apparatus B15, firstly, transmits a request T1 to be connected to the hierarchical structure to the connection candidate introduction apparatus C.

The connection candidate introduction apparatus C, on receiving the connection request T1 from the new terminal apparatus B15 by means of the connection request reception unit, acquires, from the new terminal apparatus B15 which has transmitted the connection request T1, connection information (a node number and IP address) of the new terminal apparatus B15, and stores them, and subsequently, as shown in FIG. 3B, on receiving a reconnection request T4 from the new terminal apparatus B15, transmits connection information T2, relating to a terminal apparatus B which is a connection destination, to the new terminal apparatus B15 which has transmitted the reconnection request T4.

The connection candidate introduction apparatus C of the embodiment does not go so far as to manage a connection aspect of the terminal apparatus B which currently configure the hierarchical structure but, as shown in FIG. 3B, it does manage node numbers and IP addresses of all the terminal apparatus B1, B3, B4, B7, B8, B9 and B10 which configure the hierarchical structure and, herein, it selects the node numbers and IP addresses of three terminal apparatus B, the terminal apparatus B3, B4 and B7, as the connection information T2, and transmits them to the new terminal apparatus B15.

The new terminal apparatus B15, on acquiring the connection information T2 from the connection candidate introduction apparatus C by means of the connection candidate acquisition unit, transmits a connection request T3 to the three terminal apparatus B3, B4 and B7 sequentially, as shown in FIG. 3C, and receives, from the terminal apparatus B to which the connection request T3 has been transmitted, information indicating whether or not a connection is possible.

As each terminal apparatus B which receives the connection request T3 from the new terminal apparatus B15 manages information relating to a terminal apparatus B connected downstream of itself, it determines, referring to this information, whether or not it is possible to connect the new terminal apparatus B15 downstream of itself.

Herein, as shown in FIG. 3A, as the terminal apparatus B3 already has the two terminal apparatus B7 and B8 connected downstream of itself, and the terminal apparatus B4 already has the two terminal apparatus B9 and B10 connected downstream of itself, these two terminal apparatus B3 and B4 transmit information to the new terminal apparatus B15 indicating that the connection is impossible.

Contrarily, as shown in FIG. 3A, as the terminal apparatus B7 does not have another terminal apparatus B connected downstream of itself, it transmits information to the new terminal apparatus B15 indicating that the connection is possible.

Then, the new terminal apparatus B15 establishes the connection with the terminal apparatus B7, which has transmitted the information indicating that the connection is possible, and receives a relay of data from the terminal apparatus B7.

At this time, the terminal apparatus B7 connected with the new terminal apparatus B15, based on its own connection position information, calculates connection position information of the new terminal apparatus B15 by means of the downstream connection position calculation unit.

Herein, the connection position information of the terminal apparatus B7 being (000/3), as the new terminal apparatus B15 is connected to a downstream left side of the terminal apparatus B7, the connection position information of the new terminal apparatus B15 becomes (0000/4).

Then, the terminal apparatus B7 transmits the connection position information (0000/4) of the new terminal apparatus B15, calculated in this way, to the new terminal apparatus B15, by means of the downstream connection position transmission unit.

In the embodiment, by configuring each terminal apparatus B in this way, all of the terminal apparatus B connected to the hierarchical structure can acquire and store connection position information relating to themselves, as shown in FIG. 2.

Also, the terminal apparatus B includes a connection candidate position acquisition unit which acquires, from a terminal apparatus B which is a connection candidate corresponding to connection information acquired by the connection candidate acquisition unit, connection position information of that terminal apparatus B, and a connection destination selection unit which, based on the connection position information of the terminal apparatus B which is the connection candidate acquired by the connection candidate position acquisition unit, and on the connection position information of its own apparatus acquired by the connection position acquisition unit, selects, as a connection destination, a terminal apparatus B which is a connection candidate of which a connection position is not farther downstream in the hierarchical structure than a connection position of its own apparatus.

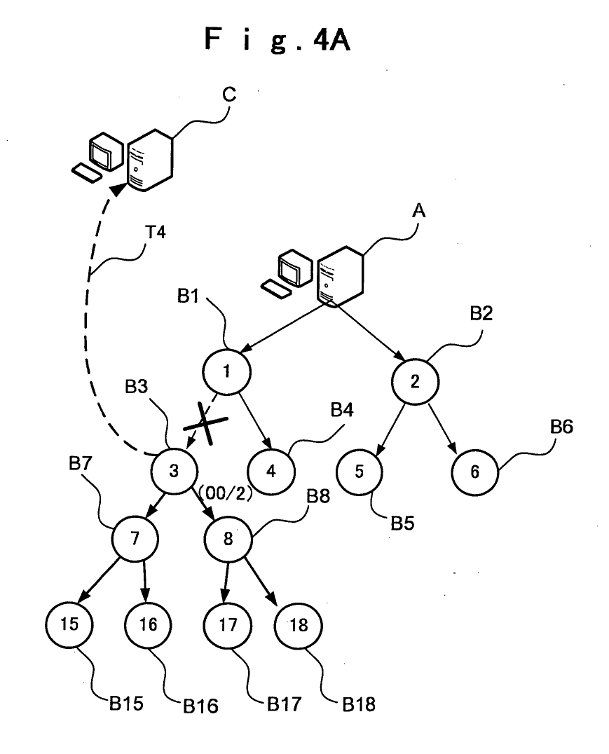

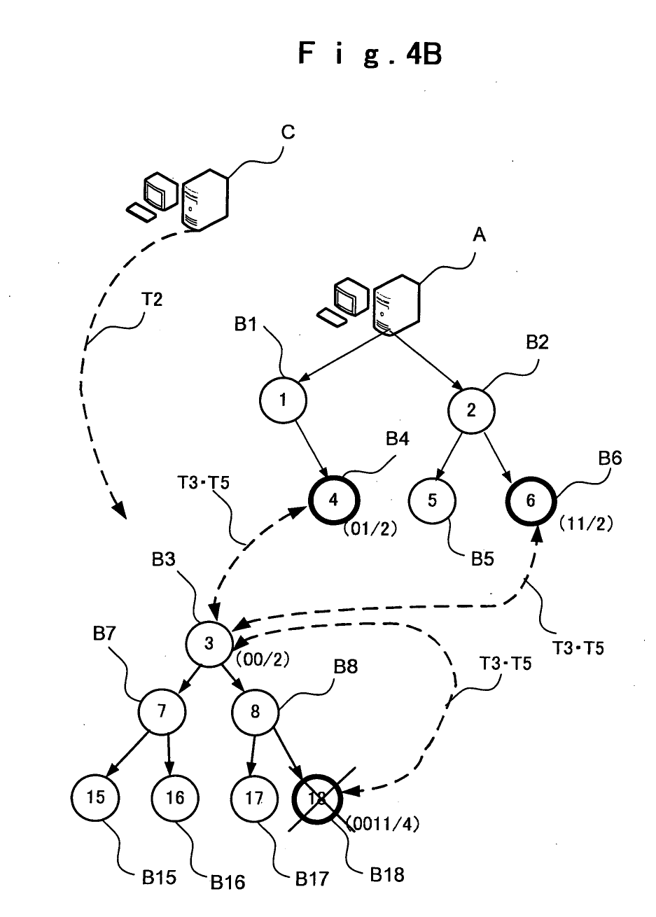

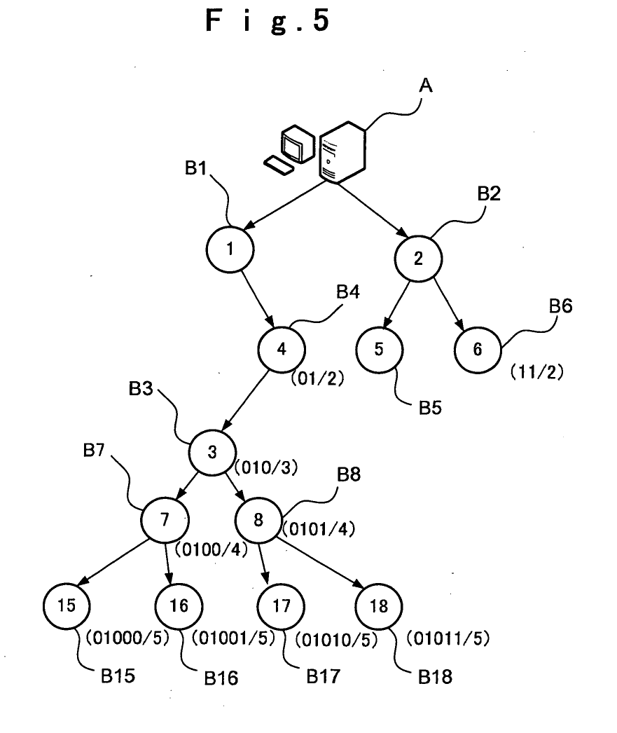

Herein, a description will be given, referring to FIGS. 4A, 4B and 5, of a first procedure from a terminal apparatus B, which has another terminal apparatus B connected downstream of itself, temporarily withdrawing from the hierarchical structure, until connecting to a terminal apparatus B different from that to which it has been connected before withdrawing. Herein, a description will be given with, as an example, a case in which the terminal apparatus B3, which has a plurality of terminal apparatus B7, B8 and B15 to B18 connected downstream of itself, and has connection position information of (00/2), temporarily withdraws from the hierarchical structure, and connects again to the hierarchical structure, as shown in FIG. 4A.

As shown in FIG. 4A, the terminal apparatus B3 which temporarily withdraws from the hierarchical structure (herein referred to as a “reconnecting terminal apparatus B3”), firstly, transmits the reconnection request T4, to the connection candidate introduction apparatus C, indicating that it will temporarily withdraw from, then reconnect to, the hierarchical structure.

The connection candidate introduction apparatus C, on receiving the reconnection request T4 from the reconnecting terminal apparatus B3, by means of the reconnection request reception unit, transmits connection information T2 of a terminal apparatus which is a connection candidate to the reconnecting terminal apparatus B3, as shown in FIG. 4B.

Herein, the connection candidate introduction apparatus C transmits, as connection candidates, node numbers and IP addresses of three terminal apparatus, B4, B6 and B18, to the reconnecting terminal apparatus B3.

The reconnecting terminal apparatus B3, on acquiring the terminal apparatus B4, B6 and B18, which are the connection candidates, from the connection candidate introduction apparatus C, by means of the connection candidate acquisition unit, transmits the connection request T3 to the three terminal apparatus B4, B6 and B18 sequentially, and receives, from the terminal apparatus B to which the connection request T3 has been transmitted, information indicating whether or not a connection is possible.

Herein, as shown in FIG. 4B, as there is no terminal apparatus B connected downstream of the three terminal apparatus B4, B6 and B18, which are the connection candidates, the reconnecting terminal apparatus B3 receives information from the three terminal apparatus B4, B6 and B18 indicating that the connection is possible.

Also, the reconnecting terminal apparatus B3, at this time, acquires, by means of the connection candidate position acquisition unit, from the three terminal apparatus B4, B6 and B18 which are the connection candidates, connection position information T5 of the terminal apparatus B4, B6 and B18.

Herein, the reconnecting terminal apparatus B3 acquires connection position information T5 of (01/2) from the terminal apparatus B4, (11/2) from the terminal apparatus B6, and (0011/4) from the terminal apparatus B18.

Then, in the reconnecting terminal apparatus B3, the connection destination selection unit selects a terminal apparatus B which is a connection destination, based on the connection position information (01/2), (11/2) and (0011/4) T5, acquired by means of the connection candidate position acquisition unit, and on connection position information (00/2) of its own apparatus.

At this time, the connection destination selection unit determines from the connection position information that the terminal-apparatus B18 is a terminal apparatus B connected downstream of its own apparatus, and selects either one of the other two terminal apparatus B4 and B6 as the connection destination. Herein, it selects the terminal apparatus B4 as the connection destination, and connects.

In this way, as the terminal apparatus B of the embodiment is configured in such a way that, based on connection position information of a terminal apparatus B which is a connection candidate, and on its own connection position information, it selects a terminal apparatus B to be a connection destination, excluding from connection candidates a terminal apparatus B which forms a circular connection when connecting, it is possible to prevent the circular connection from occurring when carrying out a reconnection.

Then, as shown in FIG. 5, the reconnecting terminal apparatus B3, on connecting to the terminal apparatus B4, obtains its own new connection position information (010/3) from the upstream terminal apparatus B4, by means of the connection position acquisition unit, and updates its own connection position information.

At this time, the reconnecting terminal apparatus B3, as the two terminal apparatus B7 and B8 are connected downstream of it, calculates connection position information, (0100/4) and (0101/4) respectively, for the terminal apparatus B7 and B8 connected downstream of itself, based on its own updated connection position information, and transmits the respective information to the two downstream terminal apparatus B7 and B8.

Also, as two terminal apparatus are also connected downstream of each of the two terminal apparatus B7 and B8, the two terminal apparatus B7 and B8 also, in the same way, calculate new connection position information of the terminal apparatus B15 to B18 connected downstream, and transmit it.

Also, the terminal apparatus B of the embodiment includes an in-reconnection connection position acquisition unit which acquires, from the connection candidate introduction apparatus C, connection position information stored in the in-reconnection connection position storage unit.

The in-reconnection connection position acquisition unit acquires, from the connection candidate introduction apparatus C, a list (hereafter referred to as an “in-reconnection list”) of path information, depth information and the like, relating to a terminal apparatus B which is currently being reconnected, but for which the reconnection to the hierarchical structure is not complete.

Then, the connection destination selection unit of the terminal apparatus B, referring to the in-reconnection list, selects a terminal apparatus B which is a connection destination from terminal apparatus B, among terminal apparatus B which are connection candidates introduced by the connection candidate introduction apparatus C, other than terminal apparatus B corresponding to the connection position information acquired by the in-reconnection connection position acquisition unit, or to connection position information of a terminal apparatus B connected downstream thereof.

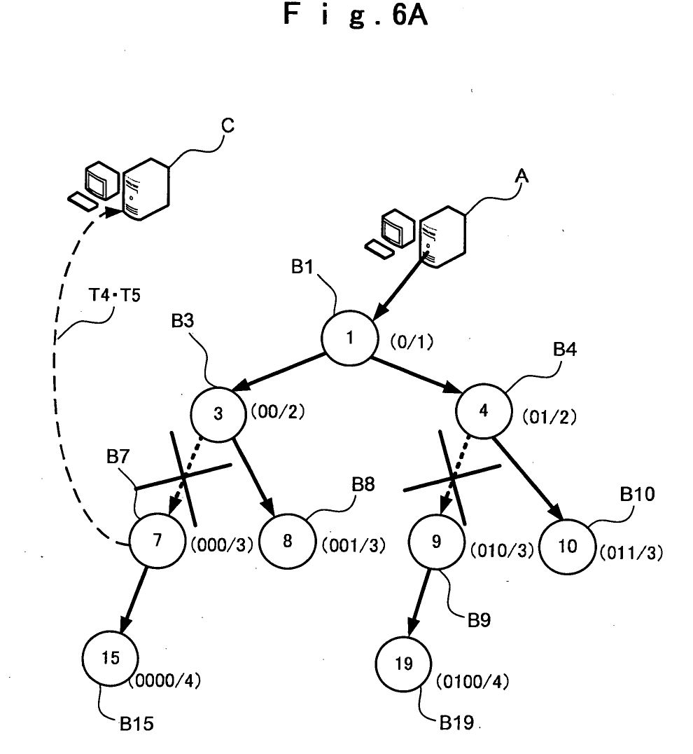

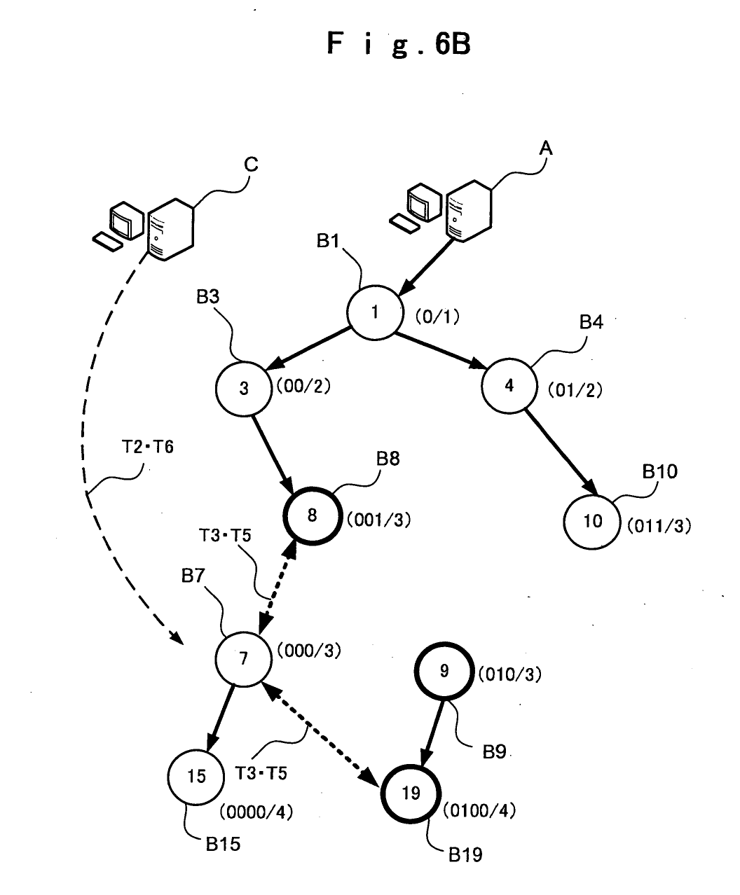

Herein, a description will be given, referring to FIGS. 6A, 6B, 7, 8A and 8B, of a second procedure from a terminal apparatus B, which has another terminal apparatus B connected downstream of itself, temporarily withdrawing from the hierarchical structure, until connecting to a terminal apparatus B different from that to which it has been connected before withdrawing. Herein, a description will be given with, as an example, a case in which, when the two terminal apparatus B7 and B9, which each has a terminal apparatus B connected downstream of itself, withdraw approximately simultaneously from the hierarchical structure, one of the terminal apparatus, B7, connects again to the hierarchical structure, as shown in FIG. 6A.

As shown in FIG. 6A, the terminal apparatus B7 (herein referred to as a “first reconnecting terminal apparatus B7”) which temporarily withdraws from the hierarchical structure and connects again to the hierarchical structure, firstly, transmits the reconnection request T4 to the connection candidate introduction apparatus C. At this time, the first reconnecting terminal apparatus B7 transmits its own connection position information T5 to the connection candidate introduction apparatus C.

Although not shown here, at this time, the other terminal apparatus which carries out the reconnection, B9 (herein referred to as a “second reconnecting terminal apparatus B9”) also transmits the reconnection request T4 and its own connection position information T5 to the connection candidate introduction apparatus C.

The connection candidate introduction apparatus C, as well as receiving the reconnection request T4 from the first reconnecting terminal apparatus B7, by means of the reconnection request reception unit, receives the connection position information T5 from the first reconnecting terminal apparatus B7, by means of the in-reconnection connection position reception unit, and registers it stored in the in-reconnection connection position storage unit.

At this time, the connection candidate introduction apparatus C also registers the connection position information received from the second reconnecting terminal apparatus B9 stored in the in-reconnection connection position storage unit.

The connection candidate introduction apparatus C, by compiling, by means of the in-reconnection connection position storage unit, an in-reconnection list table in which is registered the connection position information T5 of the terminal apparatus B being reconnected (herein, the terminal apparatus B7 and B9), registers the connection position information T5 of the terminal apparatus B being reconnected, and stores it until the reconnection of the registered terminal apparatus B being reconnected is complete.

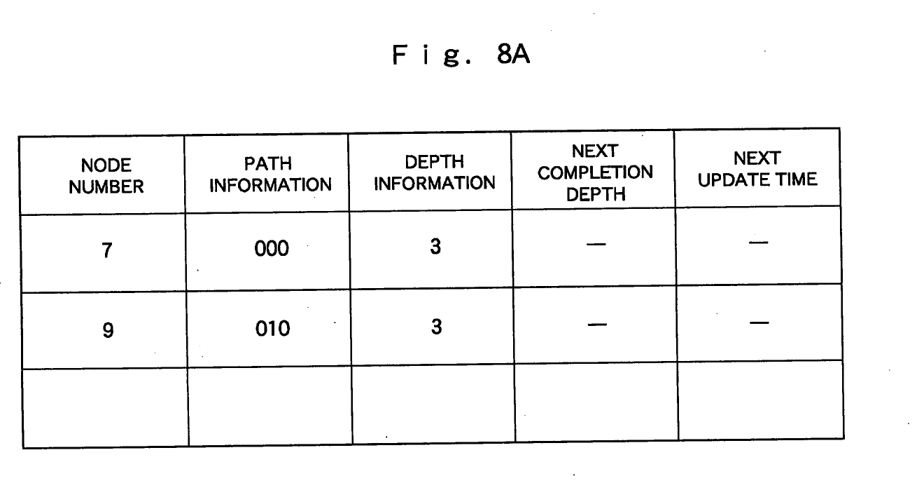

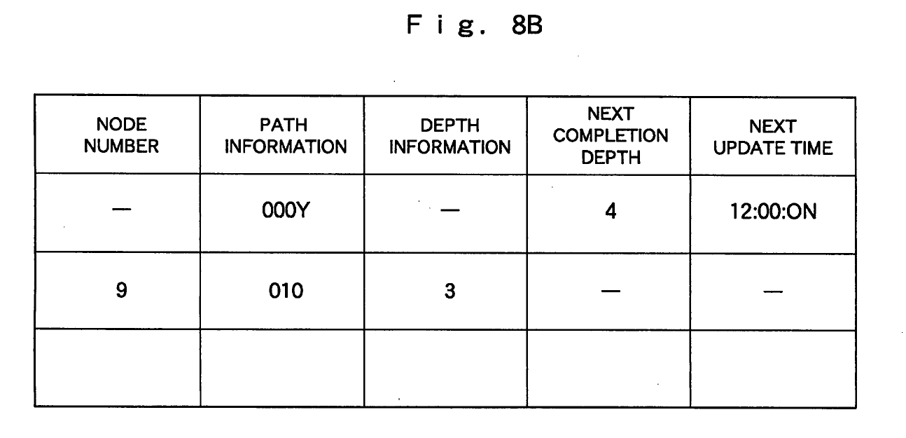

One example of the in-reconnection list table is shown in FIGS. 8A and 8B. As shown in FIG. 8A, a node number, path information, depth information, and information such as a next completion depth and a next update time, to be described hereafter, of the first reconnecting terminal apparatus B7 and the second reconnecting terminal apparatus B9, which are currently being reconnected, but for which the reconnection to the hierarchical structure is not yet complete, are registered in the in-reconnection list table.

Subsequently, the connection candidate introduction apparatus C, as shown in FIG. 6B, transmits connection information of a plurality of terminal apparatus B, which are connection candidates, and an in-reconnection list T6 registered in the in-reconnection list table, to the first reconnecting terminal apparatus B7, which has transmitted the reconnection request, by means of the connection position transmission unit.

Herein, the connection candidate introduction apparatus C, as well as transmitting node numbers and IP addresses of three terminal apparatus B8, B9 and B19, as the connection information T2, transmits the path information and the depth information of the first reconnecting terminal apparatus B7 and the second reconnecting terminal apparatus B9 as the in-reconnection list T6.

Then, in the first reconnecting terminal apparatus B7, the connection destination selection unit selects a terminal apparatus B which is a connection destination, based on the connection information T2 of the connection candidates acquired by means of the connection candidate position acquisition unit, and on the in-reconnection list T6 acquired by means of the in-reconnection connection position acquisition unit.

Herein, the connection destination selection unit of the first reconnecting terminal apparatus B7 eliminates from the connection candidates the terminal apparatus B9 which is included in the in-reconnection list T6, among the terminal apparatus B8, B9 and B19 which are the connection candidates introduced by the connection candidate introduction apparatus C, and selects a terminal apparatus B which is a connection destination from the remaining two terminal apparatus B8 and B19.

In this way, as the terminal apparatus B of the embodiment is configured in such a way that, when carrying out the reconnection to the hierarchical structure, it does not connect to a terminal apparatus B registered in the in-reconnection list T6, it is possible to reliably prevent it mistakenly connecting to another terminal apparatus B for which the reconnection is not complete, thereby becoming unable to receive the distribution of the data.

Then, the first reconnecting terminal apparatus B7 sequentially transmits the connection request T3 to the two terminal apparatus B8 and B19, which are the connection candidates, and acquires the connection position information T5 of the terminal apparatus B8 and B19 from the two terminal apparatus B8 and B19.

At this time, as the connection position information T5 acquired from the terminal apparatus B19 is (0100/4), the first reconnecting terminal apparatus B7 determines that the terminal apparatus B19 is a terminal apparatus B connected downstream of the second reconnecting terminal apparatus B9, which corresponds to connection information registered in the in-reconnection list T6, and does not carry out the connection.

In this way, as the terminal apparatus B of the embodiment is configured in such a way as not to connect to a terminal apparatus connected downstream of another terminal apparatus B for which the reconnection is not complete, it is possible to prevent the circular connection from occurring.

That is, herein, supposing that, in a case in which the first reconnecting terminal apparatus B7 is connected to the terminal apparatus B19, and subsequently the second reconnecting terminal apparatus B9 is connected to the terminal apparatus B15, which is connected downstream of the first reconnecting terminal apparatus B7, the circular connection occurs, and the four circularly connected terminal apparatus B7, B9, B15 and B19 become unable to receive the data distribution from the data distribution apparatus A.

However, as heretofore described, as the terminal apparatus B of the embodiment does not carry out the connection to a terminal apparatus B connected downstream of a terminal apparatus B for which the reconnection is not complete either, it is possible to prevent the circular connection from occurring between terminal apparatus B.

Herein, the connection destination selection unit of the first reconnecting terminal apparatus B7 selects, as the connection destination, the terminal apparatus B8 which, among the terminal apparatus B8, B9 and B19 which are the connection candidates, is not registered in the in-reconnection list T6, and is not the terminal apparatus B19, which is connected downstream of the terminal apparatus B9 registered in the in-reconnection list T6.

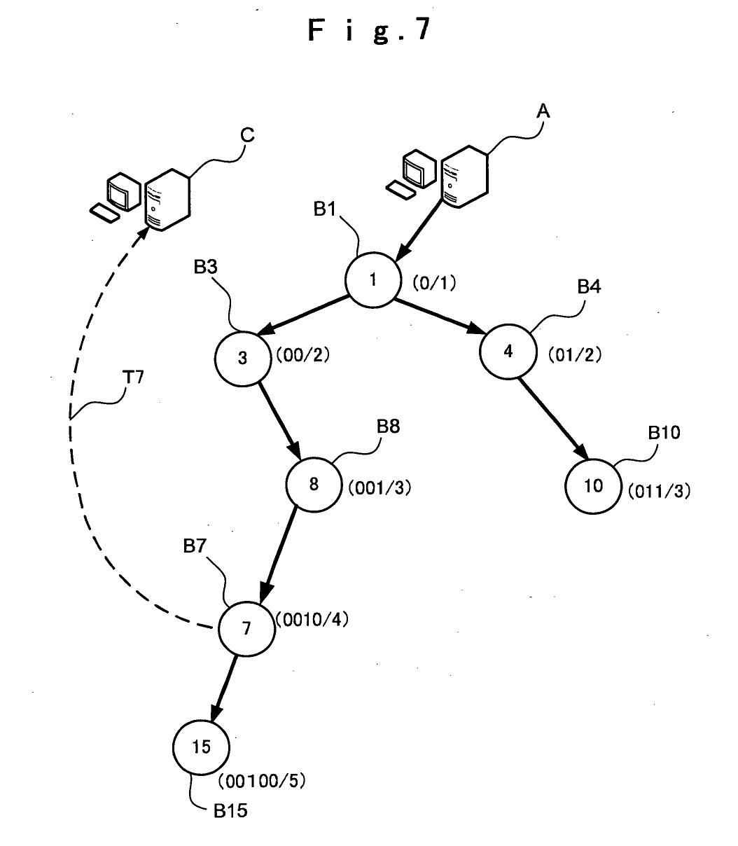

Then, the first reconnecting terminal apparatus B7, on connecting downstream of the terminal apparatus B8, acquires its own new connection position information from the terminal apparatus B8, as shown in FIG. 7. Herein, the connection position information of the terminal apparatus B8 being (001/3), the new connection position information of the first reconnecting terminal apparatus B7, as it is connected on a downstream left side of the terminal apparatus B8, is (0010/4).

Subsequently, the first reconnecting terminal apparatus B7 calculates new connection position information of the terminal apparatus B15, which is connected downstream of itself, and transmits the connection position information of (00100/5) generated by this calculation to the terminal apparatus B15, which is connected downstream.

Also, the first reconnecting terminal apparatus B7, on the reconnection to the hierarchical structure finishing in this way, transmits reconnection completion information T7 to the connection candidate introduction apparatus C indicating that the reconnection is complete.

On the connection candidate introduction apparatus C receiving the reconnection completion information T7 by means of the reconnection completion information reception unit, the connection position storage and processing unit carries out a process updating the in-reconnection list table in the in-reconnection connection position storage unit.

As shown in FIG. 8B, the connection position storage and processing unit, in response to the reconnection completion information T7 being received from the first reconnecting terminal apparatus B7, as well as deleting the node number and connection position information relating to the first reconnecting terminal apparatus B7 from the in-reconnection list table, carries out a process storing connection position information relating to a terminal apparatus B which has been connected one level downstream of the first reconnecting terminal apparatus B7, the next completion depth indicating depth information of that terminal apparatus B, and the next update time of the in-reconnection list table.

Herein, although the terminal apparatus B which is connected downstream of the first reconnecting terminal apparatus B7, for which the reconnection is complete, is the terminal apparatus B15, as the connection position storage and processing unit does not carry out an exchange of information with the terminal apparatus B15, it assumes from (000/3), which is the connection position information of the first reconnecting terminal apparatus B7, that the connection position information of the terminal apparatus B15 is (000Y (Y is either of 0 or 1)/4), registers 000Y in a path information column of the in-reconnection list table, and registers 4 in a next completion depth column.

Also, in the embodiment, an update interval of the in-reconnection list table being an N (N is a number of seconds in which it can be guaranteed that connection position information of a terminal apparatus, which is at the same depth as the next completion depth, is updated) second interval, the connection position storage and processing unit registers a time, which is N seconds added to a time at which the reconnection of the first reconnecting terminal apparatus B7 finishes, in a next update time area. In the embodiment, it is taken that the first reconnecting terminal apparatus B7 finishes the reconnection at 12 o'clock (a time of 12:00:00).

In the connection candidate introduction apparatus C of the embodiment, the connection position storage and processing unit is configured in such a way that, after the reconnection of the terminal apparatus B which has transmitted the reconnection request is complete, it sequentially registers and updates the path information, the next completion depth, and the next update time for only as far as a terminal apparatus B connected D (D is an optionally settable number) levels farther downstream than that terminal apparatus B, and subsequently deletes them.

By this means, the connection candidate introduction apparatus C, after the reconnection of the terminal apparatus B which has transmitted the reconnection request is complete, can, at least D×N seconds later, delete the information relating to the terminal apparatus B which has transmitted the reconnection request, and to terminal apparatus B connected farther downstream than that terminal apparatus B, meaning that it is possible to make a storage area secured as the in-reconnection list table as small as possible, and moreover, it is also possible to make an information volume of an in-reconnection list, transmitted to the terminal apparatus B which has transmitted the reconnection request, as small as possible.

Description of Configuration and the Like of Data Distribution Apparatus

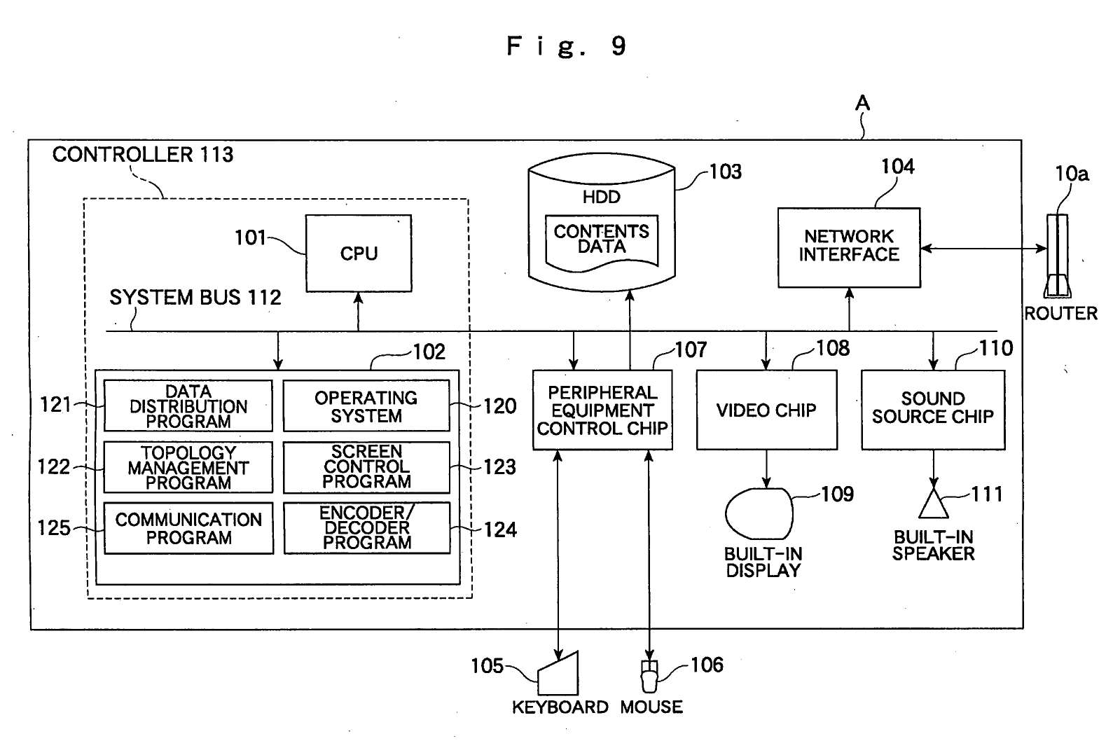

Herein, a description will be given of a configuration and the like of the data distribution apparatus A of the embodiment. FIG. 9 is a functional block diagram showing an outline configuration of the data distribution apparatus A in the data distribution system S of the embodiment.

The data distribution apparatus A, as shown in FIG. 9, being configured including a CPU (Central Processing Unit) 101, a first memory 102, as a rewritable main storage device which stores various kinds of program and the like, a second memory 103, configured of an HDD (Hard Disc Drive), or the like, which stores various kinds of data and the like, a network interface 104, which carries out communication with terminal apparatus B via the internet, a peripheral equipment control chip 107, which controls an input portion capable of inputting predetermined information, such as a keyboard 105 or a mouse 106, a video chip 108 which, as well as receiving image data from the CPU 101 and writing them into an internal video memory (not shown), displays the data written into the video memory on a display 109, to be described hereafter, the display 109, which carries out a display in accordance with a signal transmitted from the video chip 108, a sound source chip 110, which has a sound source such as an FM (Frequency Modulation) sound source or a Wave Table sound source, and a speaker 111, which converts an audio signal transmitted from the sound source chip 110 into a sound wave, these various components are mutually connected via a system bus 112. In the embodiment, a controller 113 is configured of the CPU 101 and the first memory 102. The network interface 104 is connected to a network via a router 10a.

First Memory 102

An OS (Operating System) program 120 for providing basic functions of the data distribution apparatus A as a computer, a data distribution program 121 for retrieving contents data stored in the second memory 103, and distributing them to a terminal apparatus B, a topology management program 122 for carrying out management and the like of a node number and IP address of a terminal apparatus B connected one level downstream in the hierarchical structure, a screen control program 123 for controlling the display 109, an encoder/decoder program 124 for decoding encoded contents data, and encoding the contents data, a communication program 125 executed for carrying out an exchange of various kinds of data among terminal apparatus B, and the like being stored in the first memory 102, they are retrieved by the CPU 101, and functions according to the programs are executed by the CPU 101.

Herein, the OS program 120, by being retrieved and executed by the CPU 101, renders executable functions relating to an input and output of the keyboard 105 and mouse 106, and the basic functions of the computer, which is the data distribution apparatus A, such as a memory management of the first memory 102, the second memory 103, and the like. Then, in a condition in which the OS program 120 is executed by the CPU 101, the heretofore described data distribution program 121, topology management program 122, screen control program 123, encoder/decoder program 124, communication program 125, and the like, are executed.

It is also acceptable that the OS program 120, data distribution program 121, topology management program 122, screen control program 123, encoder/decoder program 124, and communication program 125 are, for example, downloaded into the first memory 102 from a server, or the like, connected to the internet, and it is also acceptable that, after being recorded on a recording medium such as a CD-ROM, they are written into the first memory 102 via a drive of the recording medium.

Controller 113

The controller 113, being configured, as heretofore described, of the CPU 101 and first memory 102, centrally controls a whole of the data distribution apparatus A by the CPU 101 retrieving and executing the various kinds of program 120 to 124 stored in the first memory 102.

Description of configuration and the Like of Terminal Apparatus

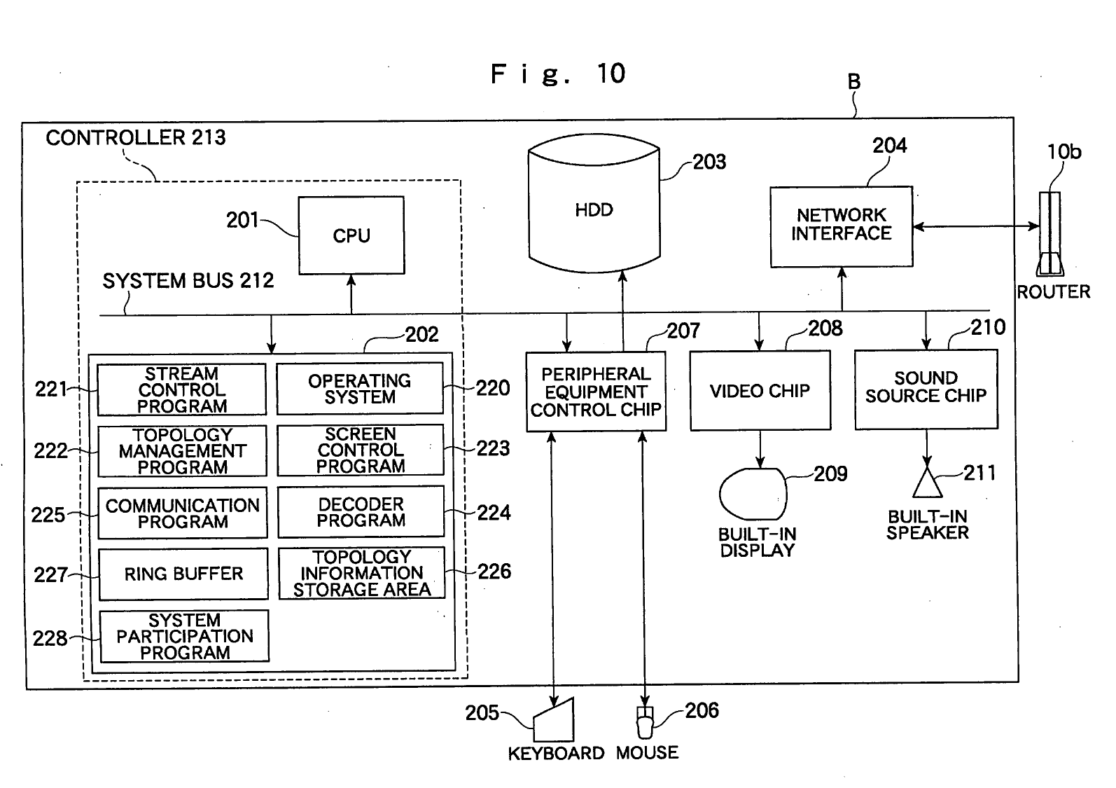

Next, a description will be given of a configuration and the like of the terminal apparatus B of the embodiment, referring to FIG. 10.

FIG. 10 is a functional block diagram showing an outline configuration example of the terminal apparatus B in the embodiment. The terminal apparatus B, a general personal computer being applicable, as shown in FIG. 10, being configured including a CPU 201, a first memory 202, as a rewritable main storage device which stores various kinds of program and the like, a second memory 203, configured of an HDD, or the like, which stores various kinds of data and the like, a network interface 204, which carries out communication with the data distribution apparatus A and the connection candidate introduction apparatus C via the internet, a peripheral equipment control chip 207, which controls an input portion capable of inputting predetermined information, such as a keyboard 205 or a mouse 206, a video chip 208 which, as well as receiving image data from the CPU 201 and writing them into an internal video memory (not shown), displays the data written into the video memory on a display 209, to be described hereafter, the display 209, which carries out a display in accordance with a signal transmitted from the video chip 208, a sound source chip 210, which has a sound source such as an FM sound source or a Wave Table sound source, and a speaker 211, which converts an audio signal transmitted from the sound source chip 210 into a sound wave, these various components are mutually connected via a system bus 212. In the embodiment, a controller 213 is configured of the CPU 201 and the first memory 202. The network interface 204 is connected to the network via a router 10b.

First Memory 202

Also, an OS program 220 for providing basic functions of the terminal apparatus B as a computer, a system participation program 228 executed for participating in the data distribution system S of the embodiment, a stream control program 221 for, as well as receiving contents data distributed streamed directly from the data distribution apparatus A or relayed through another terminal apparatus B, relaying the received contents data to another terminal apparatus B connected downstream, a topology management program 222 executed for carrying out a connection to the hierarchical structure and a withdrawal from the hierarchical structure, a screen control program 223 for controlling the display 209, a decoder program 224 for decoding encoded contents data, a communication program 225 executed for carrying out an exchange of various kinds of data with the data distribution apparatus A, the connection candidate introduction apparatus C, and another terminal apparatus B, and the like being stored in the first memory 202, these programs are retrieved by the CPU 201, and functions according to the programs are executed by the CPU 201.

Also, the first memory 202 includes a topology information storage area 226, which stores various kinds of information used for carrying out the connection to the hierarchical structure and the withdrawal from the hierarchical structure, such as connection position information of its own apparatus in the hierarchical structure, connection information of a terminal apparatus B which is a connection candidate acquired from the connection candidate introduction apparatus C, and an in-reconnection list, and a ring buffer 227 which temporarily stores the received contents data. In the embodiment, the heretofore described topology information storage area 226 functions as the in-reconnection connection position storage unit in the embodiment of the invention.

Herein, the OS program 220, by being retrieved and executed by the CPU 201, renders executable the basic functions of the computer, which is the terminal apparatus B, such as a memory management of the first memory 202, the second memory 203, and the like. Then, in a condition in which the OS program 220 is executed by the CPU 201, the heretofore described system participation program 228, stream control program 221, topology management program 222, screen control program 223, decoder program 224, communication program 225, and the like, are executed.

It is also acceptable that the OS program 220, system participation program 228, stream control program 221, topology management program 222, screen control program 223, decoder program 224, communication program 225, and the like are, for example, downloaded into the first memory 202 from a server, or the like, connected to the internet, and it is also acceptable that, after being recorded on a recording medium such as a CD-ROM, they are written into the first memory 202 via a drive of the recording medium.

Also, in the embodiment, each program, the system participation program 228, stream control program 221, topology management program 222, screen control program 223, decoder program 224, communication program 225, and the like, is described separately, but it is also acceptable to configure in such a way that each of these programs is stored in the first memory 202 as one data distribution system program.

Controller 213

The controller 213, being configured, as heretofore described, of the CPU 201 and first memory 202, centrally controls a whole of the terminal apparatus B, and functions as the heretofore described connection position acquisition unit, connection candidate acquisition unit, connection candidate position acquisition unit, connection destination selection unit, downstream connection position calculation unit, downstream connection position transmission unit, in-reconnection connection position acquisition unit, and the like, by the CPU 201 retrieving and executing the various kinds of program 220 to 224, and 228, stored in the first memory 202.

Description of Configuration and the Like of Connection Candidate Introduction Apparatus

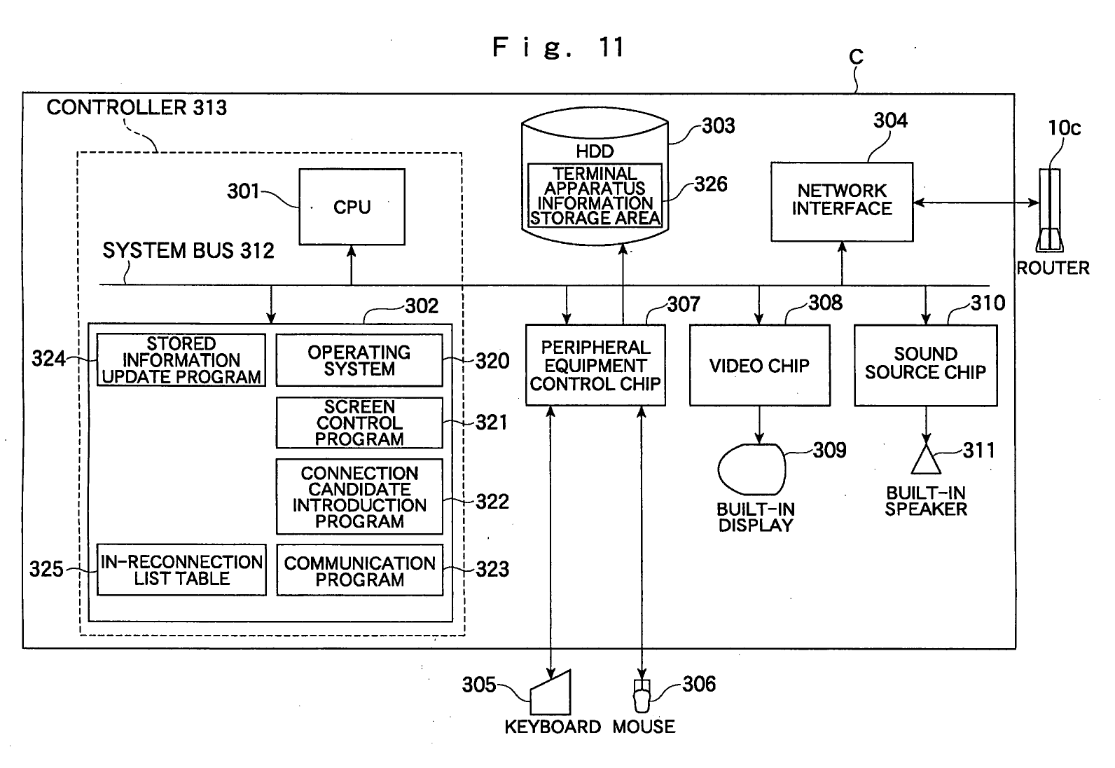

Next, a description will be given of a configuration and the like of the connection candidate introduction apparatus C, referring to FIG. 11.

FIG. 11 is a functional block diagram showing an outline configuration example of the connection candidate introduction apparatus C in the embodiment. The connection candidate introduction apparatus C, a general server computer being applicable, as shown in FIG. 11, being configured including a CPU 301, a first memory 302, as a rewritable main storage device which stores various kinds of program and the like, a second memory 303, configured of an HDD, or the like, which stores various kinds of data and the like, a network interface 304, which carries out communication with terminal apparatus B via the internet, a peripheral equipment control chip 307, which controls an input portion capable of inputting predetermined information, such as a keyboard 305 or a mouse 306, a video chip 308 which, as well as receiving image data from the CPU 301 and writing them into an internal video memory (not shown), displays the data written into the video memory on a display 309, a sound source chip 310, which has a sound source such as an FM sound source or a Wave Table sound source, and a speaker 311, which converts an audio signal transmitted from the sound source chip 310 into a sound wave, these various components are mutually connected via a system bus 312. In the embodiment, a controller 313 is configured of the CPU 301 and the first memory 302. The network interface 304 is connected to the internet via a router 10c.

First Memory 302

Also, the first memory 302 including an in-reconnection list table 325, which stores information relating to a terminal apparatus B being reconnected, and to a terminal apparatus B connected farther downstream than that terminal apparatus B, the in-reconnection list table 325 functions as the in-reconnection connection position storage unit in the embodiment of the invention.

Also, an OS program 320 for providing basic functions of the connection candidate introduction apparatus C as a computer, a screen control program 321 for controlling the display 309, a connection candidate introduction program 322 for transmitting connection information of a terminal apparatus B, which is a connection candidate, to a terminal apparatus B which has transmitted a request for connection, or a request for reconnection, to the hierarchical structure, a communication program 323 executed for carrying out an exchange of various kinds of data among the terminal apparatus B, a stored information update program 324 executed for carrying out an update of information stored in the in-reconnection list table 325, and in a terminal apparatus information storage area 326, to be described hereafter, and the like being stored in the first memory 302, they are retrieved by the CPU 301, and functions according to the programs are executed by the CPU 301.

Herein, the OS program 320, by being retrieved and executed by the CPU 301, renders executable functions relating to an input and output of the keyboard 305 and mouse 306, and the basic functions of the computer, which is the connection candidate introduction apparatus C, such as a memory management of the first memory 302, the second memory 303, and the like. Then, in a condition in which the OS program 320 is executed by the CPU 301, the screen control program 321, connection candidate introduction program 322, communication program 323, stored information update program 324, and the like, are executed.

It is also acceptable that the OS program 320, screen control program 321, connection candidate introduction program 322, communication program 323, stored information update program 324, and the like are, for example, downloaded into the first memory 302 from a server, or the like, connected to the internet, and it is also acceptable that, after being recorded on a recording medium such as a CD-ROM, they are written into the first memory 302 via a drive of the recording medium.

Second Memory 303

The hard disc device, which is the second memory 303, includes the terminal apparatus information storage area 326, which stores connection information indicating node numbers and IP addresses relating to all the terminal apparatus B connected to the hierarchical structure.

Controller 313

The controller 313, being configured, as heretofore described, of the CPU 301, the first memory 302, and the second memory 303, as well as retrieving connection information of a plurality of terminal apparatus B which the CPU 301 optionally selects from the second memory 303, centrally controls a whole of the connection candidate introduction apparatus C, and functions as the heretofore described connection request reception unit, reconnection request reception unit, in-reconnection connection position reception unit, connection position transmission unit, reconnection completion information reception unit, connection position storage and processing unit, and the like, by retrieving and executing the in-reconnection list table 325, and the various kinds of program 320 to 324, stored in the first memory 302.

Processes Carried Out By Connection Candidate Introduction Apparatus C Controller

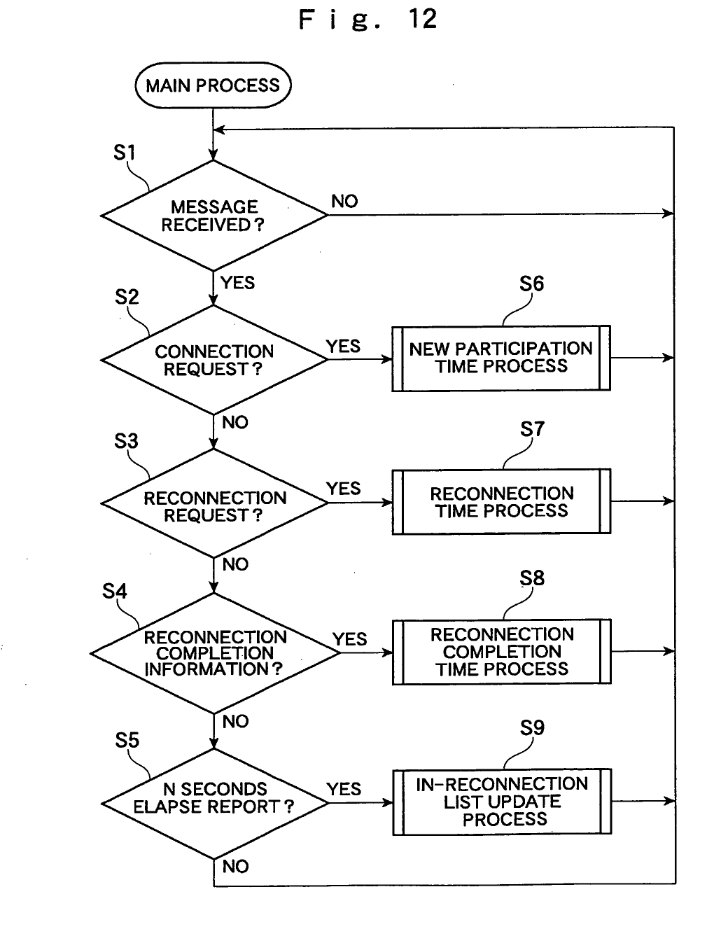

Herein, a description will be given, referring to FIGS. 12 to 16, of information processes which the CPU 301 carries out, by retrieving the programs stored in the first memory 302, in the controller 313 of the connection candidate introduction apparatus C according to the embodiment. Herein, the description will be given referring to the controller 313 of the connection candidate introduction apparatus C simply as the controller 313.

Main Process

The controller 313 carries out a main process shown in FIG. 12 for a time from power being turned on until it is turned off.

That is, as shown in FIG. 12, the controller 313, on the power being supplied, firstly, determines whether or not a message has been received from a terminal apparatus B or from an unshown internal clock device (step S1).

Herein, if it determines that the message has been received (step S1: yes), the controller 313 moves the process to step S2, while if it determines that the message has not been received (step S1: no), it returns the process to step S1.

In step S2, the controller 313 determines whether or not the received message is a connection request and, if it determines that it is a connection request from a terminal apparatus B which is trying to newly connect to the hierarchical structure (step S2: yes), it moves the process to step S6, executes a new participation time process, to be described hereafter, and subsequently returns the process to step S1.

Contrarily, if the controller 313 determines that the received message is not the connection request from the terminal apparatus B which is trying to newly connect to the hierarchical structure (step S2: no), it moves the process to step S3.

In step S3, the controller 313 determines whether or not the received message is a reconnection request from a terminal apparatus B and, if it determines that it is the reconnection request (step S3: yes), it moves the process to step S7, carries out a reconnection time process, to be described hereafter, and subsequently returns the process to step S1.

Contrarily, if the controller 313 determines that the received message is not the reconnection request (step S3: no), it moves the process to step S4.

In step S4, the controller 313 determines whether or not the received message is reconnection completion information and, if it determines that it is the reconnection completion information (step S4: yes), it moves the process to step S8, carries out a reconnection completion time process, to be described hereafter, and subsequently returns the process to step S1.

Contrarily, if the controller 313 determines that the received message is not the reconnection completion information (step S4: no), it moves the process to step S5.

In step S5, the controller 313 determines whether or not the received message is an N second elapse report from the internal clock device and, if it determines that it is the N second elapse report (step S5: yes), it moves the process to step S9, carries out an in-reconnection list update process, to be described hereafter, and subsequently returns the process to step S1.

Contrarily, if the controller 313 determines that the received message is not the N second elapse report (step S5: no), it returns the process to step S1.

New Participation Time Process

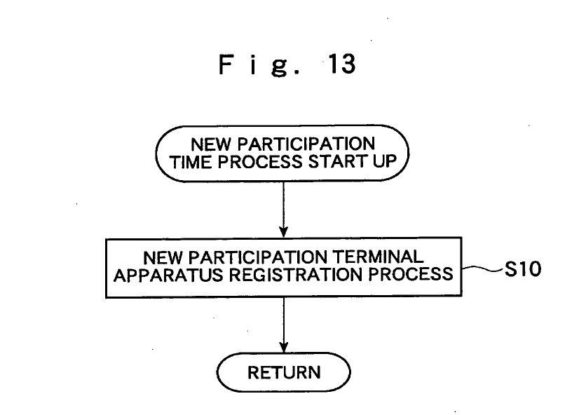

On starting up the new participation time process in step S6 of the main process, the controller 313, as shown in FIG. 13, carries out a new participation terminal apparatus registration process (step S10).

In step S10, the controller 313 receives, from the terminal apparatus B which has transmitted the connection request, a node number and IP address of that terminal apparatus B, carries out a process of storing them in the terminal apparatus information storage area 326 inside the second memory 303, and subsequently finishes the new participation time process, and returns the process to step S1 of the main process shown in FIG. 12.

Reconnection Time Process

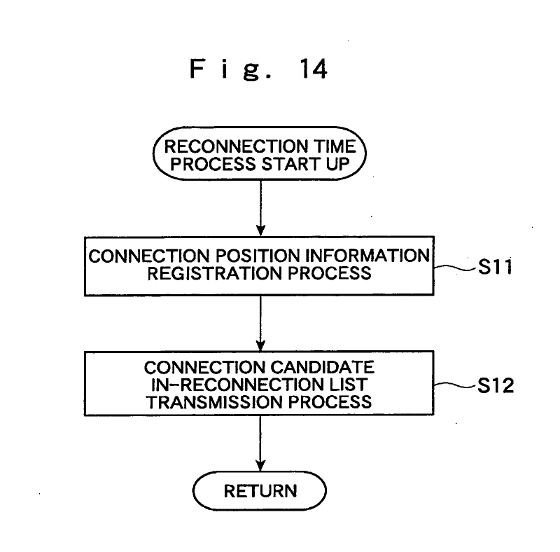

On starting up the reconnection time process in step S7 of the main process, the controller 313, as shown in FIG. 14, carries out a connection position information registration process (step S11), and subsequently moves the process to step S12.

In step S11, the controller 313 receives, from the terminal apparatus B which has transmitted the reconnection request, a node number and connection position information of that terminal apparatus B, and carries out a process of storing them in the in-reconnection list table 325 inside the first memory 302 (refer to FIG. 8A).

In step S12, the controller 313 carries out a connection candidate and in-reconnection list transmission process. In the connection candidate and in-reconnection list transmission process, the controller, as well as optionally selecting, as connection destination candidates in the hierarchical structure, a plurality of terminal apparatus B from among terminal apparatus B currently connected to the hierarchical structure, and transmitting node numbers and IP addresses of those terminal apparatus B to the terminal apparatus B which has transmitted the reconnection request, carries out a process transmitting, to the terminal apparatus B which has transmitted the reconnection request, an in-reconnection list, including information relating to a terminal apparatus B which is currently being reconnected, but for which the reconnection to the hierarchical structure is not yet complete, and subsequently finishes the reconnection time process, and returns the process to step S1 of the main process shown in FIG. 12.

Reconnection Completion Time Process

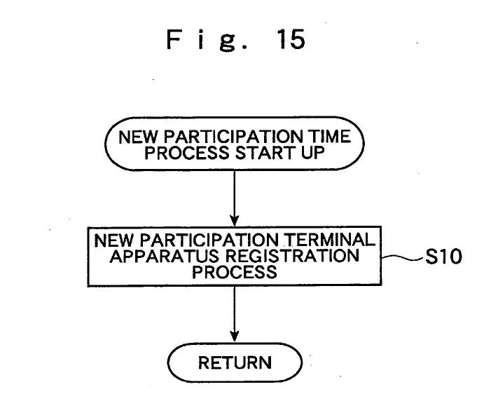

On starting up the reconnection completion time process in step S8 of the main process, the controller 313, as shown in FIG. 15, as well as registering depth information+1 in the next completion depth, carries out a process of registering the next update time (step S13), and subsequently moves the process to step S14.

At this time, the controller 313, as well as storing information on depth information+1 of a terminal apparatus B which has transmitted the reconnection completion information, in the next completion depth column of an area, in the in-reconnection list table 325, in which is stored information relating to the terminal apparatus B which has transmitted the reconnection completion information, stores a time at which the reconnection completion information is received in a next update time column (refer to FIG. 8B).

Next, instep S14, the controller 313, as well as deleting a node number and depth information of a terminal apparatus B which has completed the reconnection, carries out a process of updating the path information (refer to FIG. 8B), and subsequently finishes the reconnection completion time process, and returns the process to step S1 of the main process shown in FIG. 12.

When carrying out the update of the path information, the controller 313 carries each column of the path information to be updated one column, and carries out a process of registering a constant number Y in a now blank first column of the path information.

In-Reconnection List Update Process

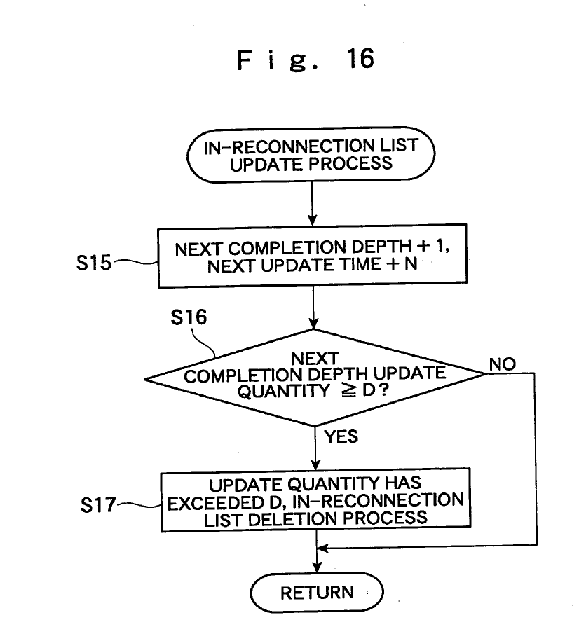

On starting up the in-reconnection list update process in step S9 of the main process, the controller 313, as shown in FIG. 16, as well as carrying out a process of adding 1 to a next completion depth, carries out a process of adding N to a next update time (step S15), and subsequently moves the process to step S16.

At this time, the controller 313, as well as carrying out a process of adding 1 to a value registered in the next completion depth column of the in-reconnection list table 325, carries out a process of adding N seconds to a time registered in the next update time column.

In step S16, the controller 313, referring to the in-reconnection list table 325, determines whether or not a number of next completion depth updates has reached a preset number D or more and, if it determines that it has reached D or more (step S16: yes), it moves the process to step S17, while if it determines that it has not reached D or more (step S16: no), it finishes the in-reconnection list update process, and returns the process to step S1 of the main process shown in FIG. 12.

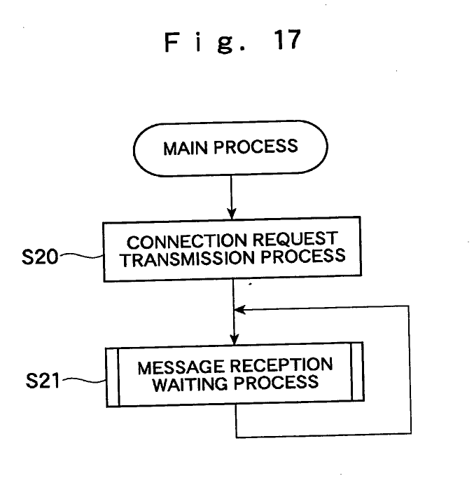

Processes carried out by terminal apparatus controller Next, a description will be given, referring to FIGS. 17 to 23, of information processes carried out by the controller 213 of the terminal apparatus B according to the embodiment. Herein, the description will be given referring to the controller 213 of the terminal apparatus B simply as the controller 213.

Main Process

The controller 213 carries out a main process shown in FIG. 17 for a time from the system participation program 228 stored in the first memory 202 being started up until it is finished.

That is, as shown in FIG. 17, the controller 213, on the system participation program 228 being started up, carries out a connection request transmission process (step S20). Herein, the controller 213 carries out a process of transmitting, to the connection candidate introduction apparatus C, a request for a connection to the hierarchical structure, and subsequently moves the process to step S21.

In step S21, the controller 213 carries out a message reception waiting process, to be described hereafter, and, while the system participation program 228 is starting up, continues the process of step S21.

Message Reception Waiting Process

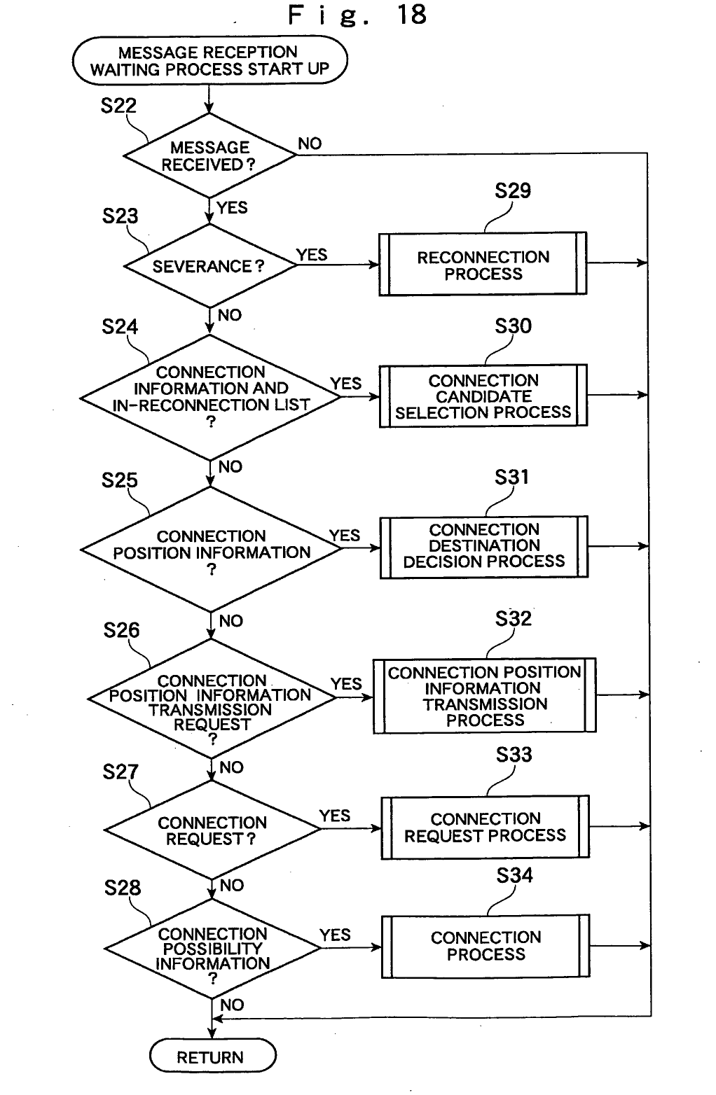

On starting up the message reception waiting process of step S21 in the main process, the controller 213, as shown in FIG. 18, determines whether or not a message has been received from any one of the data distribution apparatus A, the connection candidate introduction apparatus C, another terminal apparatus B, or its own apparatus (step S22) and, if it determines that one has been received (step S22: yes), it moves the process to step S23, while if it determines that one has not been received (step S22: no), it returns the process to step S22.

In step S23, the controller 213 determines whether or not the received message is a message indicating a severance transmitted from its own apparatus and, if it determines that it is the message indicating the severance (step S23: yes), it moves the process to step S29, carries out a reconnection process, to be described hereafter, and subsequently returns the process to step S22.

Contrarily, if the controller 213 determines that the received message is not the message indicating the severance (step S23: no), it moves the process to step S24.

In step S24, the controller 213 determines whether or not the received message is connection information and, if it determines that it is the connection information (step S24: yes), it moves the process to step S30, carries out a connection candidate selection process, to be described hereafter, and subsequently returns the process to step S22.

Contrarily, if the controller 213 determines that the received message is not the connection information (step S24: no), it moves the process to step S25.

In step S25, the controller 213 determines whether or not the received message is connection position information and, if it determines that it is the connection position information (step S25: yes), it moves the process to step S31, carries out a connection destination decision process, to be described hereafter, and subsequently returns the process to step S22.

Contrarily, if the controller 213 determines that the received message is not the connection position information (step S25: no), it moves the process to step S26.

In step S26, the controller 213 determines whether or not the received message is a connection position information transmission request and, if it determines that it is the connection position information transmission request (step S26: yes), it moves the process to step S32, carries out a connection position information transmission process, to be described hereafter, and subsequently returns the process to step S22.

Contrarily, if the controller 213 determines that the received message is not the connection position information transmission request (step S26: no), it moves the process to step S27.

In step S27, the controller 213 determines whether or not the received message is a connection request and, if it determines that it is the connection request (step S27: yes), it moves the process to step S33, carries out a connection request process, to be described hereafter, and subsequently returns the process to step S22.

Contrarily, if the controller 213 determines that the received message is not the connection request (step S27: no), it moves the process to step S28.

In step S28, the controller 213 determines whether or not the received message is connection possibility information and, if it determines that it is the connection possibility information (step S28: yes), it moves the process to step S34, carries out a connection process, to be described hereafter, and subsequently moves the process to step S22, while if it determines that the received message is not the connection possibility information (step S28: no), it returns the process to step S21.

Reconnection Process

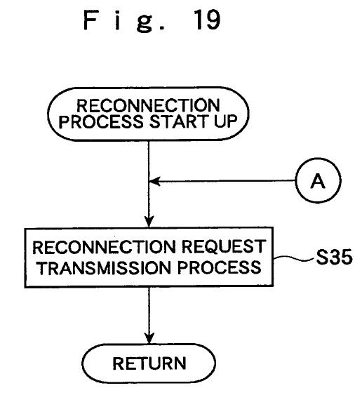

On starting up the reconnection process in step S29 of the message reception waiting process, the controller 213, as shown in FIG. 19, carries out a reconnection request transmission process (step S35).

In the reconnection process, the controller 213 carries out a process of transmitting, to the connection candidate introduction apparatus C, a reconnection request indicating a matter of temporarily withdrawing from the hierarchical structure, and connecting to the hierarchical structure again, and subsequently finishes the reconnection process, and returns the process to step S22 of the message reception waiting process.

Connection Candidate Selection Process

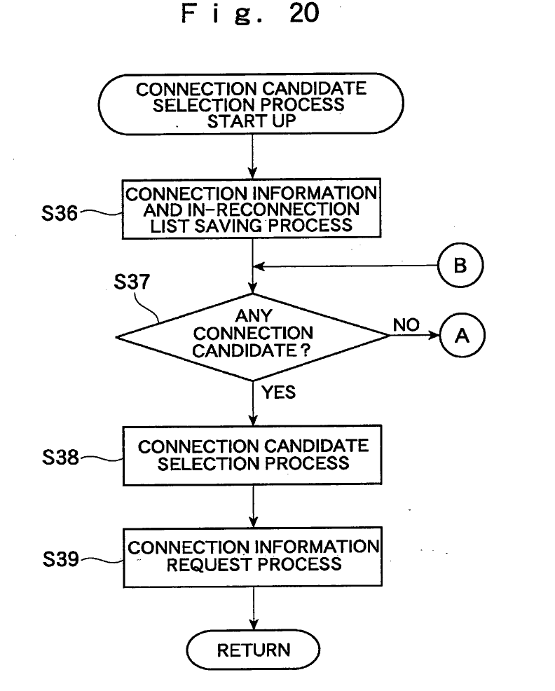

On starting up the connection candidate selection process in step S30 of the message reception waiting process, the controller 213, as shown in FIG. 20, carries out a connection information and in-reconnection list saving process (step S36).

In the connection candidate selection process, the controller 213 carries out a process of storing connection information and an in-reconnection list, acquired from the connection candidate introduction apparatus C, in the topology information storage area 226 inside the first memory 202, and subsequently moves the process to step S37.

In step S37, the controller 213 determines whether or not there is a connection candidate and, if it determines that there is a connection candidate (step S37: yes), it moves the process to step S38, while if it determines that there is no connection candidate (step S37: no), it moves the process to step S35 shown in FIG. 19.

In step S38, the controller 213 carries out the connection candidate selection process selecting, as connection candidates, terminal apparatus B, among connection candidates acquired from the connection candidate introduction apparatus C, which are not in the in-reconnection list, and subsequently moves the process to step S39.

In step S39, the controller 213 carries out a connection information request process. In the connection information request process, the controller 213 carries out a process transmitting, to a terminal apparatus B which is the connection candidate selected in step S38, a transmission request for connection information of that terminal apparatus B, and subsequently finishes the connection candidate selection process, and returns the process to step S22 of the message reception waiting process.

Connection Destination Decision Process

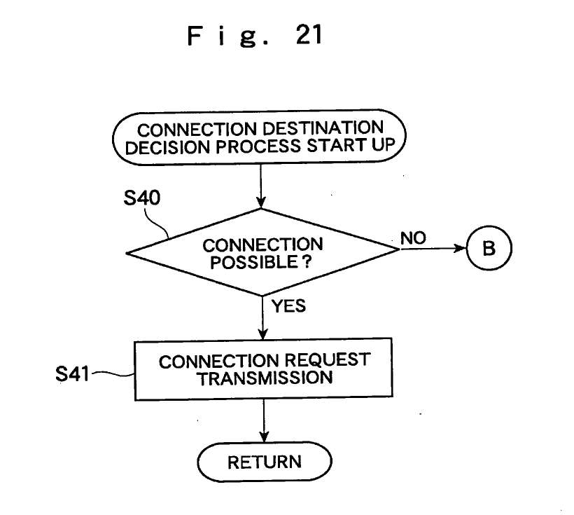

On starting up the connection destination decision process in step S31 of the message reception waiting process, the controller 213, as shown in FIG. 21, determines whether or not a connection to the terminal apparatus B which has transmitted the connection position information is possible (step S40) and, if it determines that the connection is possible (step S40: yes), it moves the process to step S41, while if it determines that the connection is impossible (step S40: no), it moves the process to step S37 shown in FIG. 20.

At this time, if the controller 213, referring to the connection position information acquired from the terminal apparatus B selected as the connection candidate, and to the in-reconnection list, determines that the terminal apparatus B selected as the connection candidate is not a terminal apparatus connected farther downstream than its own apparatus, a terminal apparatus B being reconnected, or a terminal apparatus B connected downstream of the terminal apparatus B being reconnected, it determines that the connection is possible.

In step S41, the controller 213 carries out the connection request transmission process transmitting a connection request to the terminal apparatus B determined to be connectable in step S40, and subsequently finishes the connection destination decision process, and returns the process to step S22 of the message reception waiting process.

Connection Position Information Transmission Process

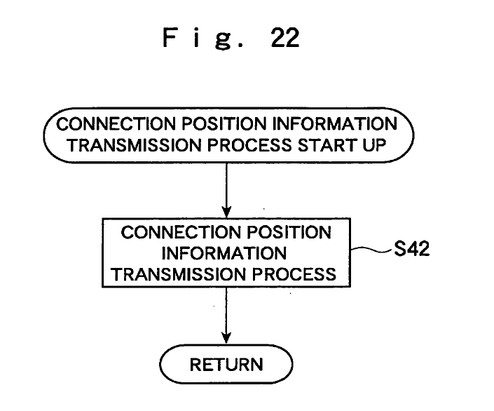

On starting up the connection position information transmission process in step S32 of the message reception waiting process, the controller 213, as shown in FIG. 22, carries out the connection position information transmission process, transmitting connection position information of its own apparatus to a terminal apparatus which has transmitted the connection position information transmission request (step S42), and subsequently finishes the connection position information transmission process, and returns the process to step S22 of the message reception waiting process.

Connection Request Process

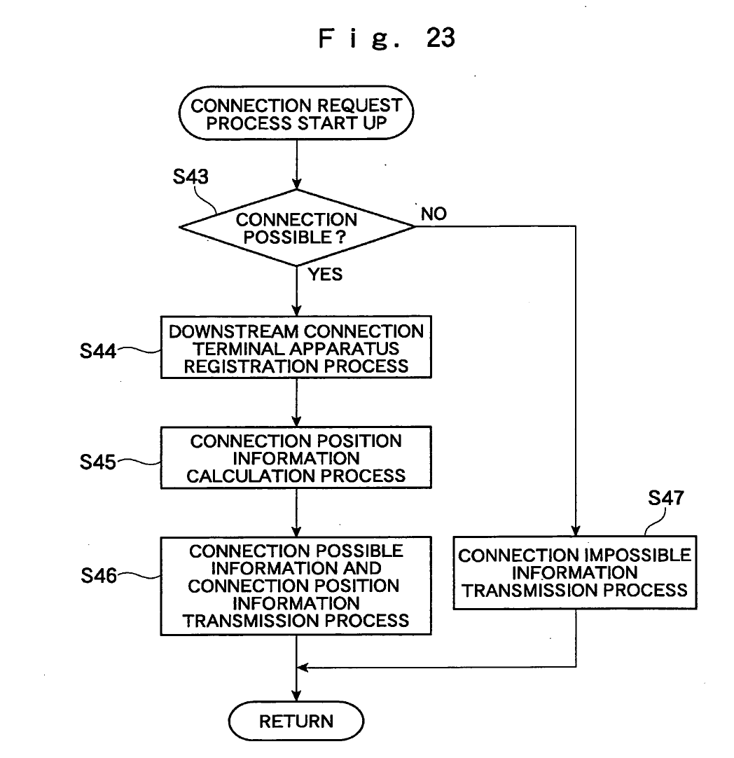

On starting up the connection request process in step S33 of the message reception waiting process, the controller 213, as shown in FIG. 23, determines whether or not a connection to a terminal apparatus B which has transmitted the connection request is possible (step S43). Herein, the controller 213 determines that the connection is possible if a quantity of other terminal apparatus B connected downstream of its own apparatus is one or less, and determines that the connection is impossible if two terminal apparatus B are connected downstream of its own apparatus.

Then, in step S43, if the controller 213 determines that the connection is possible (step S43: yes), it moves the process to step S44, while if it determines that the connection is impossible (step S43: no), it moves the process to step S47.

In step S47, the controller 213 carries out a connection impossible information transmission process transmitting, as the connection possibility information, connection impossible information, indicating that the connection is impossible, to the terminal apparatus B which has transmitted the connection request, and subsequently finishes the connection request process, and returns the process to step S22 of the message reception waiting process.

Also, in step S44, the controller 213 carries out a downstream terminal apparatus registration process, registering the terminal apparatus B which has transmitted the connection request as a terminal apparatus B to be connected downstream, and subsequently moves the process to step S45.

In step S45, the controller 213 carries out a connection position information calculation process, and subsequently moves the process to step S46. In the connection position information calculation process, the controller 213 calculates connection position information of the terminal apparatus B registered in step S44, based on connection position information of its own apparatus.

At this time, the controller 213, as well as adding 1 to depth information of its own apparatus, carries each column of path information of its own apparatus by one column and, by making 1 or 0 a first column of the path information, decided depending on which of left and right sides downstream of its own apparatus the terminal apparatus B registered in step S44 is connected to, generates new connection position information of the terminal apparatus B registered in step S44.

Next, in step S45, the controller 213 carries out a connection possible information transmission process transmitting, as the connection possibility information, connection possible information, indicating that the connection is possible, to the terminal apparatus B which has transmitted the connection request, and subsequently finishes the connection request process, and returns the process to step S22 of the message reception waiting process.

Connection Process

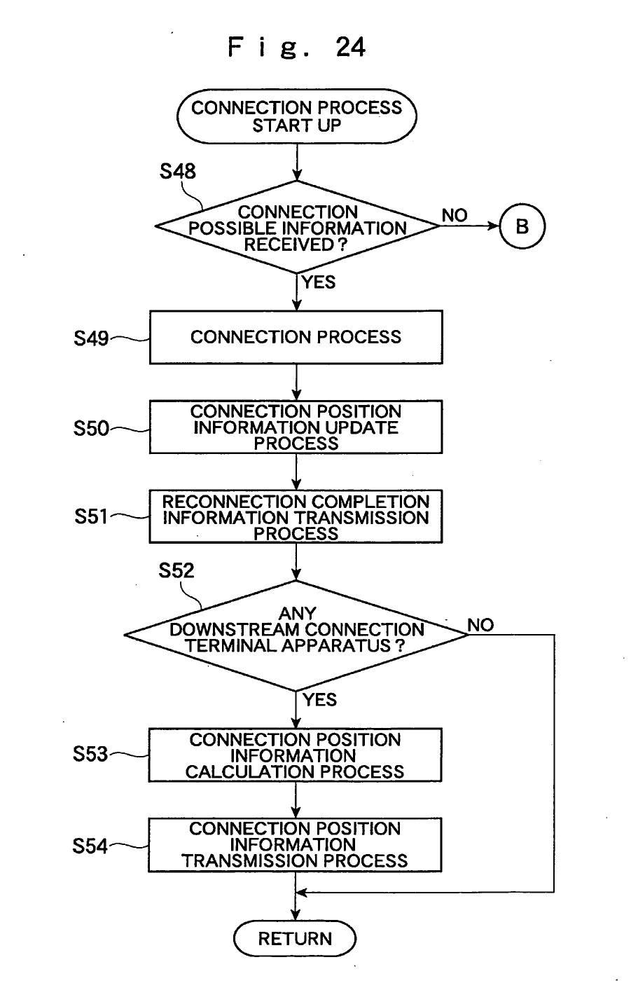

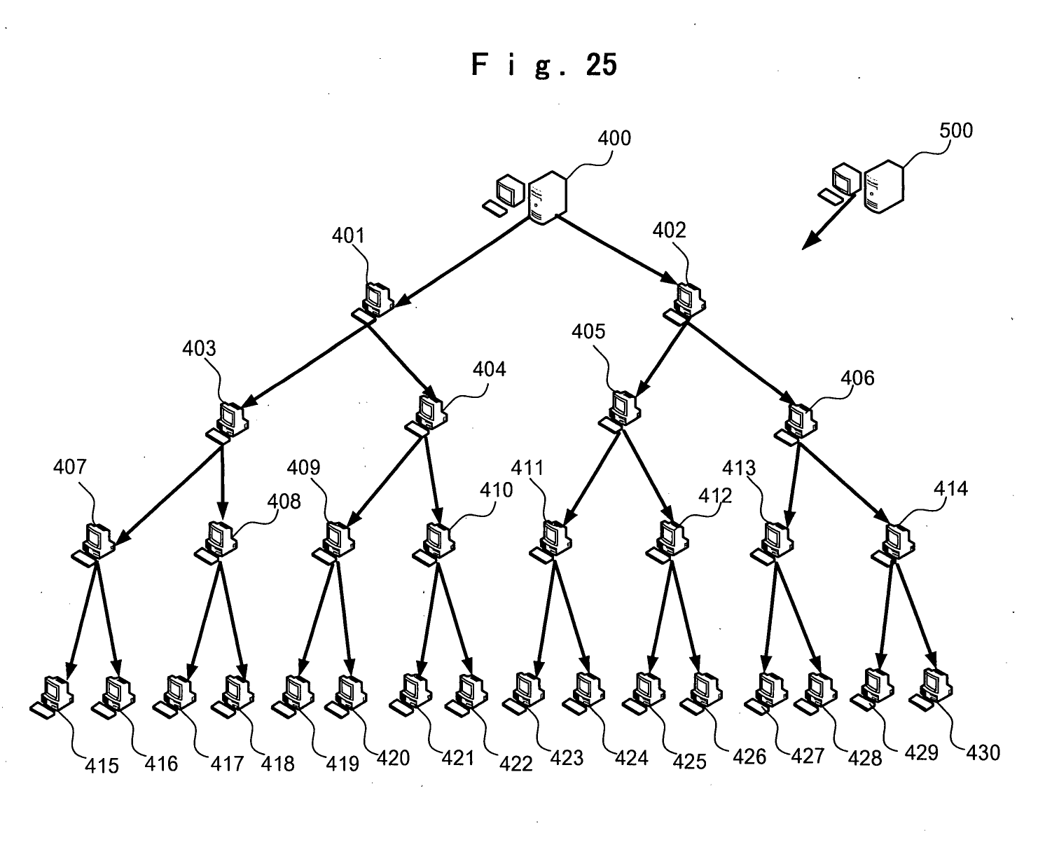

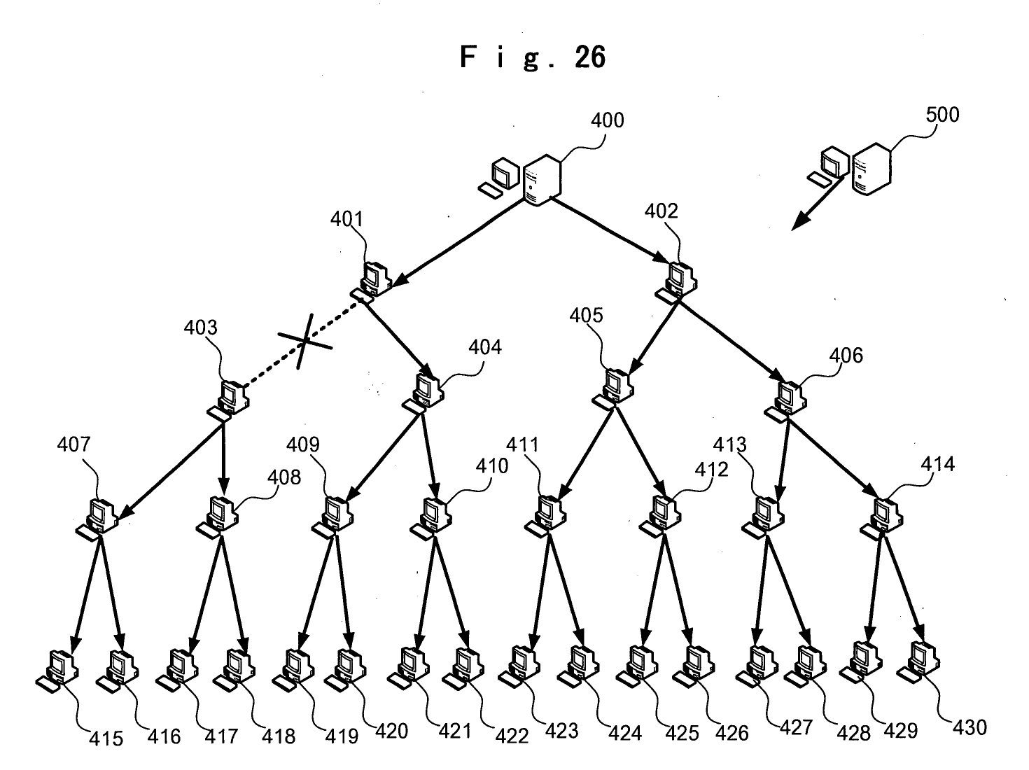

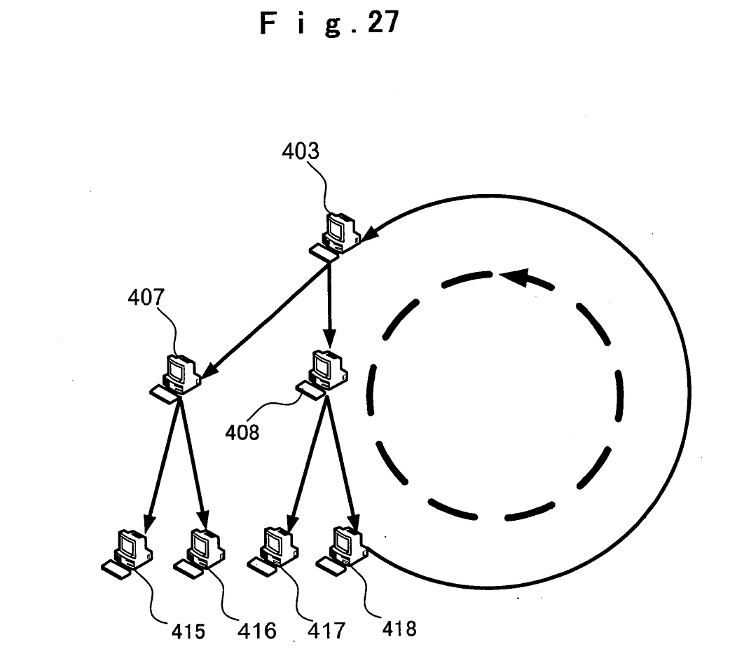

On starting up the connection process in step S34 of the message reception waiting process, the controller 213, as shown in FIG. 24, determines whether or not the received connection possibility information is the connection possible information (step S48) and, if it determines that it is the connection possible information (step S48: yes), it moves the process to step S49, carries out the connection process connecting to the terminal apparatus B which has transmitted the connection request, and subsequently moves the process to step S50.

In step S50, the controller 213 carries out a connection position information update process, storing new connection position information, acquired from the terminal apparatus B which has transmitted the connection request, in the topology information storage area 226 of the first memory 202, and subsequently moves the process to step S51.

In step S51, the controller 213 carries out a reconnection completion information transmission process transmitting reconnection completion information, indicating that the reconnection to the hierarchical structure is complete, to the connection candidate introduction apparatus C, and subsequently moves the process to step S52.

In step S52, the controller 213 determines whether or not there is a terminal apparatus B connected downstream of its own apparatus (hereafter, referred to as a “downstream terminal apparatus B”) and, if it determines that there is a downstream terminal apparatus B (step S52: yes), it moves the process to step S53, while if it determines that there is no downstream terminal apparatus B (step S52: no), it finishes the connection process, and returns the process to step S22 of the message reception waiting process.

In step S53, the controller 213 carries out the connection position information calculation process, calculating new connection position information of the downstream terminal apparatus B, and subsequently moves the process to step S54.

In step S54, the controller 213 carries out the connection position information transmission process, transmitting the connection position information calculated by means of the calculation of step S53 to the downstream terminal apparatus B, and subsequently finishes the connection process, and returns the process to step S22 of the message reception waiting process.

Although the embodiment and modification of the present invention have been described in detail herein, the scope of the invention is not limited thereto. It will be appreciated by those skilled in the art that various modifications may be made without departing from the scope of the invention. Accordingly, the embodiment and modification disclosed herein are only exemplary. It is to be understood that the scope of the invention is not to be limited thereby, but is to be determined by the claims which follow.

What is claimed is:

1. A data distribution system comprising:
a data distribution apparatus which distributes data via a network;
a plurality of terminal apparatus, logically connected, in a multilevel hierarchical structure on the network, with the data distribution apparatus as an apex, which receive and relay data distributed from the data distribution apparatus; and
a connection candidate introduction apparatus, which introduces terminal apparatus which are hierarchical structure connection candidates to a terminal apparatus which has transmitted a request for a connection to the hierarchical structure,
the data distributed from the data distribution apparatus being sequentially distributed, by a relay function of the terminal apparatus, from an upstream terminal apparatus of the hierarchical structure to a downstream terminal apparatus, wherein
each terminal apparatus includes:
a connection position acquisition unit which acquires connection position information indicating a connection position of its own apparatus in the hierarchical structure, in a condition in which it is connected to the hierarchical structure;
a connection candidate acquisition unit which acquires, from the connection candidate introduction apparatus, connection information for connecting to terminal apparatus which are the connection candidates, when reconnecting to the hierarchical structure;
a connection candidate position acquisition unit which acquires, from terminal apparatus corresponding to the connection information acquired by the connection candidate acquisition unit, connection position information of those terminal apparatus; and
a connection destination selection unit which selects, as a connection destination, a terminal apparatus among the connection candidates, of which the connection position in the hierarchical structure is not farther downstream than the connection position of its own apparatus, based on the connection position information acquired by the connection candidate position acquisition unit, and on the connection position information acquired by the connection position acquisition unit.

2. The data distribution system according to claim 1, wherein
the connection position information is information which specifies a connection position of the terminal apparatus in the hierarchical structure, by a data distribution route from the data distribution apparatus to the terminal apparatus.

3. The data distribution system according to claim 1, wherein
the connection position acquisition unit carries out an acquisition of the connection position information from an upstream terminal apparatus connected to its own apparatus.

4. The data distribution system according to claim 1, wherein
each terminal apparatus further includes:
a downstream connection position calculation unit which calculates connection position information of a terminal apparatus connected downstream of its own apparatus; and
a downstream connection position transmission unit which transmits the connection position information calculated by the downstream connection position calculation unit.

5. The data distribution system according to claim 1, wherein
the connection candidate introduction apparatus includes:
a reconnection request reception unit which receives, from a terminal apparatus, a request for a reconnection to the hierarchical structure;
an in-reconnection connection position reception unit which receives, from the terminal apparatus which has transmitted the reconnection request, connection position information of that terminal apparatus;
an in-reconnection connection position storage unit which stores the connection position information, received by the in-reconnection connection position reception unit, for a time until a reconnection of the terminal apparatus which has transmitted the reconnection request is complete; and
a connection position transmission unit which transmits the connection position information stored in the in-reconnection connection position storage unit to the terminal apparatus which has transmitted the reconnection request,
the terminal apparatus further includes:
an in-reconnection connection position acquisition unit, which acquires the connection position information stored in the in-reconnection connection position storage unit from the connection candidate introduction apparatus, and
the connection destination selection unit selects a terminal apparatus which is a connection destination from terminal apparatus, among the terminal apparatus which are the connection candidates introduced by the connection candidate introduction apparatus, other than terminal apparatus corresponding to the connection position information acquired by the in-reconnection connection position acquisition unit, or to connection position information downstream thereof.

6. The data distribution system according to claim 5, wherein
the connection candidate introduction apparatus further includes:
a reconnection completion information reception unit which receives, from a terminal apparatus, reconnection completion information indicating that the reconnection to the hierarchical structure is complete; and
a connection position storage and processing unit which, in response to the reconnection completion information reception unit receiving the reconnection completion information, deletes the connection position information of the terminal apparatus for which the reconnection is complete from the in-reconnection connection position storage unit.

7. The data distribution system according to claim 6, wherein
the connection position storage and processing unit, when deleting the connection position information from the in-reconnection connection position storage unit, repeats a storage and update process a predetermined number times which stores connection position information of a terminal apparatus connected downstream of a terminal apparatus corresponding to the connection position information to be deleted, and deletes it after a predetermined period elapses.

8. A terminal apparatus in a data distribution system which includes: a data distribution apparatus which distributes data via a network; a plurality of terminal apparatus, logically connected, in a multilevel hierarchical structure on the network, with the data distribution apparatus as an apex, which receive and relay data distributed from the data distribution apparatus; and a connection candidate introduction apparatus which introduces terminal apparatus which are hierarchical structure connection candidates to a terminal apparatus which has transmitted a request for a connection to the hierarchical structure, the data distributed from the data distribution apparatus being sequentially distributed, by a relay function of the terminal apparatus, from an upstream terminal apparatus of the hierarchical structure to a downstream terminal apparatus, the terminal apparatus comprising:
a connection position acquisition unit which acquires connection position information indicating a connection position of its own apparatus in the hierarchical structure, in a condition in which it is connected to the hierarchical structure;
a connection candidate acquisition unit which acquires, from the connection candidate introduction apparatus, connection information for connecting to terminal apparatus which are the connection candidates, when reconnecting to the hierarchical structure;
a connection candidate position acquisition unit which acquires, from terminal apparatus corresponding to the connection information acquired by the connection candidate acquisition unit, connection position information of those terminal apparatus; and
a connection destination selection unit which selects, as a connection destination, a terminal apparatus among the connection candidates, of which the connection position in the hierarchical structure is not farther downstream than the connection position of its own apparatus, based on the connection position information acquired by the connection candidate position acquisition unit, and on the connection position information acquired by the connection position acquisition unit.

9. A connection candidate introduction apparatus in a data distribution system which includes: a data distribution apparatus which distributes data via a network; a plurality of terminal apparatus, logically connected, in a multilevel hierarchical structure on the network, with the data distribution apparatus as an apex, which receive and relay data distributed from the data distribution apparatus; and a connection candidate introduction apparatus which introduces terminal apparatus which are hierarchical structure connection candidates to a terminal apparatus which has transmitted a request for a connection to the hierarchical structure, the data distributed from the data distribution apparatus being sequentially distributed, by a relay function of the terminal apparatus, from an upstream terminal apparatus of the hierarchical structure to a downstream terminal apparatus, the connection candidate introduction apparatus comprising:
a reconnection request reception unit which receives, from a terminal apparatus, a request for a reconnection to the hierarchical structure;
an in-reconnection connection position reception unit which receives, from the terminal apparatus which has transmitted the reconnection request, connection position information of that terminal apparatus;
an in-reconnection connection position storage unit which stores the connection position information, received by the in-reconnection connection position reception unit, for a time until a reconnection of the terminal apparatus which has transmitted the reconnection request is complete; and
a connection position transmission unit which transmits the connection position information stored in the in-reconnection connection position storage unit to the terminal apparatus which has transmitted the reconnection request.

10. A recording medium on which is recorded a program for causing a computer to function as each unit of the terminal apparatus according to claim 8.

11. A recording medium on which is recorded a program for causing a computer to function as each unit of the connection candidate introduction apparatus according to claim 9.

12. An information processing method in a data distribution system which includes: a data distribution apparatus which distributes data via a network; a plurality of terminal apparatus, logically connected, in a multilevel hierarchical structure on the network, with the data distribution apparatus as an apex, which receive and relay data distributed from the data distribution apparatus; and a connection candidate introduction apparatus which introduces terminal apparatus which are hierarchical structure connection candidates to a terminal apparatus which has transmitted a request for a connection to the hierarchical structure, the data distributed from the data distribution apparatus being sequentially distributed, by a relay function of the terminal apparatus, from an upstream terminal apparatus of the hierarchical structure to a downstream terminal apparatus, the method comprising:
a step of a terminal apparatus acquiring connection position information indicating its own connection position in the hierarchical structure, in a condition in which it is connected to the hierarchical structure;
a step of the terminal apparatus acquiring, from the connection candidate introduction apparatus, connection information for connecting to terminal apparatus which are the connection candidates, when reconnecting to the hierarchical structure;
a step of the terminal apparatus acquiring, from terminal apparatus corresponding to the connection information acquired from the connection candidate introduction apparatus, connection position information of those terminal apparatus; and
a step of the terminal apparatus selecting, as a connection destination, a terminal apparatus among the connection candidates, of which the connection position in the hierarchical structure is not farther downstream than its own connection position, based on the connection position information of the terminal apparatus which are the connection candidates, and on its own connection position information.
